(19) United States
(12) Patent Application Publication
(10) Pub. No.: US 2025/0124704 A1
(43) Pub. Date: Apr. 17, 2025

(54) ENHANCED NEURAL NETWORK SYSTEMS AND METHODS FOR PREDICTING IMAGE SYNCHRONIZATION

(71) Applicant: Digimarc Corporation, Beaverton, OR (US)

(72) Inventors: Dimitris Chachakis, Rochester, NY (US); Tomas Filler, Beaverton, OR (US)

(21) Appl. No.: 18/917,794

(22) Filed: Oct. 16, 2024

Related U.S. Application Data
(60) Provisional application No. 63/553,917, filed on Feb. 15, 2024.
(60) Provisional application No. 63/623,170, filed on Jan. 19, 2024.
(60) Provisional application No. 63/622,294, filed on Jan. 18, 2024.
(60) Provisional application No. 63/594,409, filed on Oct. 30, 2023.
(60) Provisional application No. 63/590,692, filed on Oct. 16, 2023.

(51) Int. Cl. G06V 10/82; G06T 1/00; G06T 3/02; G06T 3/4046; G06T 3/60; G06T 7/73; G06V 10/44; G06V 10/52; G06V 10/764; G06V 10/766; G06V 10/77; G06V 10/776

(52) U.S. Cl. CPC G06V 10/82; G06T 1/0064; G06T 3/02; G06T 3/4046; G06T 3/60; G06T 7/74; G06V 10/457; G06V 10/52; G06V 10/764; G06V 10/766; G06V 10/7715; G06V 10/776; G06T 2207/20081; G06T 2207/20084

(57) ABSTRACT

One aspect of the technology includes recovering image affine transforms via CNN-based classification and regression. Another aspect of the technology is a CNN-based network to detect a presence/absence of a digital watermark signal and recovery of affine transform coefficients associated with an image template. Other aspects, features and arrangements are also described and claimed.

### RELATED APPLICATION DATA

This application claims the benefit of US Provisional Patent Application Nos. 63/553,917, Feb. 15, 2024, 63/623,170, filed Jan. 19, 2024, 63/622,294, filed Jan. 18, 2024, 63/594,409, filed Oct. 30, 2023, and 63/590,692, filed Oct. 16, 2023. This application is related to assignee's US Published Application Nos. US20220270199A1, US20210357690A1, US20200356813A1 and US20190266749A; and U.S. Pat. Nos. 11,704,765, 11,410,263, 11,194,984 and 10,664,722. The disclosures of the above referenced patent documents are each hereby incorporated herein by reference in its entirety.

### INTRODUCTION

Artificial Intelligence (“AI”) refers to a branch of computer science and engineering that aims to create machines and systems that can perform tasks that typically require human intelligence. These tasks include problem solving, pattern recognition, planning, learning, perception, language understanding, and more. Machine learning (ML), a subset of AI, focuses on the development of algorithms that allow computers to learn from and make decisions based on data.

A neural network is a system of algorithms that attempts to recognize underlying relationships in a set of data through a process that mimics the way the human brain operates. It's a foundational concept in AI and ML applications.

Convolutional Neural Networks (CNNs) are a class of deep learning neural networks, e.g., which can be applied to analyzing visual imagery (including video) and audio content. They are designed to adaptively learn spatial hierarchies of features from images. A CNN has multiple layers, and each layer has its function. Example layers include: Convolutional Layer: This includes image feature extraction (sometimes resulting in a “feature map”). It uses convolution operations to extract features from input image. Pooling Layer: This can include spatial down-sampling to reduce spatial dimensions of a feature map, saving on computation. Fully Connected Layer(s): After convolutional and pooling layers, high-level reasoning happens here. Neurons in this layer can be connected to activations in previous layers, similar to traditional multi-layer perceptrons.

Recurrent Neural Networks (RNNs) are a class of neural networks designed to recognize patterns in sequences of data, such as text, genomes, handwriting, or time series data. They have “memory” in that they take as their input not just the current input but also the entire history of inputs you've shown them. Structure and Working: The fundamental feature of an RNN is its hidden state, which captures some information about a sequence. Looping Mechanism: The output of a layer is added to the next input and fed back into the same layer. This loop allows the network to use information from previous steps in the sequence to inform the current step.

The present technology finds application in the image processing field. One example is resolving affine transformations (e.g., angle rotation, scaling and/or image translation) in images prior to further image processing. Another example application is in the field of digital watermarking.

For purposes of this disclosure, the terms “digital watermark,” “watermark” and “data hiding” are used interchangeably. (In contrast, the term “visual watermark” means an overt mark or logo superimposed onto an image, video, or other media.). We sometimes use the terms “embedding,” “embed,” “encoding,” “encode” and “data hiding” to interchangeably mean modulating or transforming data representing digital content to include information therein. For example, data hiding may seek to hide or embed an information signal (e.g., a plural bit payload or a modified version of such, e.g., a 2-D error corrected, spread spectrum signal) in a host signal. This can be accomplished, e.g., by modulating a host signal (e.g., representing digital content) in some fashion to carry the information signal. We sometimes use the terms “encoder” and “embedder” to interchangeably means software, circuitry, an apparatus and/or module to modulate or transform data representing digital content to include information therein. Similarly, we sometimes use the terms “decode,” “detect” and “read” (and various forms thereof) to interchangeably mean analyzing content to obtain a payload or signal element embedded or encoded therein. Similarly, we sometimes use the terms “decoder,” “detector” and “reader” to interchangeably means software, circuitry, apparatus and/or module to analyze content to obtain a payload or signal element embedded or encoded therein. Digimarc Corporation headquartered in Beaverton, Oregon, USA, is a leader in the field of digital watermarking. Some of Digimarc's work in data hiding and digital watermarking is reflected, e.g., in U.S. Pat. Nos. 11,410,262; 11,410,261; 11,233,918; 11,188,996; 11,188,996; 11,062,108; 10,652,422; 10,453,163; 10,282,801; 6,947,571; 6,912,295; 6,891,959, 6,763,123; 6,718,046; 6,614,914; 6,590,996; 6,408,082; 6,122,403 and 5,862,260, and in published US Patent Application Nos. 20210110505, 20220207642 and 20220385783; and in published PCT specifications nos. WO2016153911; WO 2021/072346; and WO2020186234. Each of these patent documents is hereby incorporated by reference herein in its entirety. Of course, a great many other approaches are familiar to those skilled in the art. The artisan is presumed to be familiar with a full range of literature concerning data hiding and digital watermarking.

Recently, AI has been applied to digital watermarking embedding and detecting. AI-based digital watermarking is sometimes referred to as “deep watermark” or “Deep-AI watermarking”. For example, a signal encoder may comprise one or more trained network models (e.g., deep learning models utilizing convolutional neural networks (CNNs) and/or recurrent neural networks (RNNs)) optimize the embedding of a variable watermark payload in the host signal for robustness to attacks and perceptual quality. These trained network models are employed within the signal encoder to produce a modulated host, carrying auxiliary data (e.g., plural-bit payload). The digital watermarking may occur as the digital asset is generated. For example, a payload can be inserted into a digital asset (e.g., digital image, digital video, digital audio) during AI asset generation. A corresponding digital watermark detector may comprise one or more trained network models (e.g., deep learning models utilizing convolutional neural networks (CNNs) and/or recurrent neural networks (RNNs)) optimize the detection of a variable watermark payload in a host signal. These trained network models are employed within the signal detector to yield auxiliary data, despite the presence of noise, rotation, scaling, temporal shifts, scaling, etc. Machine trained encoders and decoders are further discussed, e.g., in assignee's U.S. Pat. Nos. 11,704,765 and 11,625,805, and in assignee's US Published Application Nos. 20220270199 and 20210357690, each of which is hereby incorporated herein in its entirety.

A non-exhaustive literature review of deep watermarking techniques includes, e.g.: [1]F. Zhu et al., “Hidden: Hiding Data with Deep Networks,” Proc. ECCV, pp. 657-672, (2018). [2]T. Bui et al., “RoSteALS: Robust Steganography using Autoencoder Latent Space,” Proc. IEEE CVPR, pp. 933-942, (2023). [3]P. Fernandez et al., “The Stable Signature: Rooting Watermarks in Latent Diffusion Models,” IEEE ICCV, (2023). [4]T. Bui et al., “TrustMark: Universal Watermarking for Arbitrary Resolution Images,” arXiv preprint arXiv:2311.18297, (2023) [5] X. Luo et al., “Distortion Agnostic Deep Watermarking,” IEEE CVPR, (2020). [6]J. Hayes et al., “Towards transformation-resilient provenance detection of digital media,” https://arxiv.org/abs/2011.07355v1, (2020). [7]P. Fernandez et al., “Watermarking Images in Self-Supervised Latent Spaces,” IEEE ICASSP, (2022). [8]X. Luo et al., “LECA: A Learned Approach for Efficient Cover-Agnostic Watermarking,” Electronic Imaging, (2023). Each of the documents in this paragraph are incorporated herein by reference in their entirety.

We understand that current deep watermarking techniques lack precise recovery of image/video geometry (e.g., synchronization). Lacking precise synchronization (e.g., a return to a base image orientation state in which a digital watermark was embedded) reduces payload capacity compared to existing digital watermarking techniques. Reduced payload and/or increased false positive rates reduce applicability to large scale deployments.

Accordingly, the below described technology provides a novel deep learning approach for digital watermark synchronization (e.g., estimation of angle rotation, scale and/or translation). Let's now consider angle rotation and scaling further so that we're all on the same page. FIG. 1A is an image of a beautiful mountain landscape. Angle rational and scale of such are shown relative to FIGS. 1B & 1C. FIG. 1B is an angle rotated (by 40°) version relative to FIG. 1A; and FIG. 1C is a cropped and scaled (4×) version relative to the FIG. 1A mountain. (Translation refers to an image offset shift from an origin position; and is particularly relevant when using so-called “image templates” with digital watermarking as further discussed below.) The below described technology allows explicit geometry predictions of transformed images relative to a base or original state, which allow for geometric inversion. For example, the below described technology may determine that FIG. 1B has been angle rotated by 40°. The FIG. 1B image can then be reverse rotated by 40° to restore the image closer to its base (or original) orientation further to image processing, e.g., including digital watermark decoding. This base or original orientation is typically associated with an orientation or geometry that existed at digital watermark embedding. Our technology is applicable to traditional techniques (e.g., based on explicit image template signals) and AI-based deep watermarking.

One aspect of the present technology includes recovering image template affine transforms via CNN-based classification and regression.

Still another aspect is a CNN-based network to: i) detect a presence/absence of a digital watermark signal in an input image, and ii) recover affine transform coefficients associated with the input image. Such a network aids both deep watermarking system (also referred to as “Deep AI watermarking”) and traditional digital watermarking systems.

The disclosure also provides support for a Convolutional Neural Network (CNN)-based system for image analysis, comprising: a feature extraction backbone configured to process input imagery and extract image features therefrom through a series of convolutional layers, a plurality of Fully Connected (FC) layers receiving the extracted image features from the feature extraction backbone, wherein the plurality of FC layers comprise: a first FC layer configured to predict the presence or absence of a digital watermark signal embedded in the input imagery, a second FC layer configured to classify an image rotation angle of the input imagery from a base state, utilizing a plurality of angle rotation bins, in which each one of the plurality of angle rotation bins is respectively associated with a range of rotation angles, a third FC layer comprising a regression model configured to refine a rotation angle estimate associated with a predicted angle rotation bin identified by the second FC layer, a graphical processing unit (GPU) configured to execute the CNN-based system, wherein the system is adapted to perform image analysis by utilizing the outputs of the first FC layer to determine the presence of a digital watermark, and the outputs of the third FC layer to yield a refined rotation angle estimate for the input imagery. In a first example of the system, the feature extraction backbone comprises multiple convolutional layers and pooling layers configured to reduce the dimensionality of the input image while preserving image features for analysis. In a second example of the system, optionally including the first example, the first FC layer executes a binary classification algorithm to detect the presence or absence of the digital watermark signal. In a third example of the system, optionally including one or both of the first and second examples, the second FC layer executes a softmax function to estimate a probable angle rotation bin. In a fourth example of the system, optionally including one or more or each of the first through third examples, the second FC layer executes a softmax function and a cross-entropy function to estimate a probable rotation angle bin. In a fifth example of the system, optionally including one or more or each of the first through fourth examples, the third FC layer executes a linear regression model to refine the rotation angle estimate associated with a probable angle rotation bin identified by the second FC layer. In a sixth example of the system, optionally including one or more or each of the first through fifth examples, the third FC layer executes a sigmoid function and a mean squared error function to refine the rotation angle estimate. In a seventh example of the system, optionally including one or more or each of the first through sixth examples, the input imagery comprises video or a still image.

The disclosure also provides support for a neural network comprising plural stages, characterized in recovering image template affine transforms via CNN-based regression.

The disclosure also provides support for a CNN-based network characterized by an interconnection to detect i) a presence/absence of a digital watermark signal embedded within an image, and ii) prediction of affine transform values associated with the image based on classification fully connected layers and regression fully connected layers.

The disclosure also provides support for a neural network apparatus comprising multiple interconnected layers, said neural network apparatus comprising: an input to receive imagery, and interconnected layers comprising: means for detecting presence or not of an image template embedded within the imagery, means for predicting angle rotation of the image template, said means for predicting angle rotation yielding a predicted angle rotation bin that is associated with a range of rotation angles, means for angle rotation regression associated with the predicted angle rotation bin, said means for angle rotation regression yielding a predicted angle rotation of the image template, means for predicting scaling of the image template, said means for predicting scaling of the image template yielding a predicted scaling bin that is associated with a range of scaling values, and means for scaling regression associated with the predicted scaling bin, said means for scaling regression yielding a predicted scaling of the image template. In a first example of the system, the imagery comprises video or a still image.

The disclosure also provides support for a neural network apparatus comprising multiple interconnected layers, said neural network apparatus comprising: an input to receive imagery, and interconnected layers comprising: means for detecting presence or not of an embedded digital watermark signal within the imagery, means for estimating angle rotation of the image by identification of an angle rotation classification bin, means for angle rotation regression associated the angle rotation classification bin, said means for angle rotation regression yielding a predicted angle rotation of the imagery, means for estimating scaling of the image by identification of a scaling classification bin, and means for scaling regression associated the scaling classification bin, said means for scaling regression yielding a predicted scaling of the imagery. In a first example of the system, the imagery comprises video or a still image.

The disclosure also provides support for a CNN-based network characterized by an interconnection to detect a presence/absence of a digital watermark signal embedded within an image, and recovery of affine transform values associated with the image. In a first example of the system in which the recovery of affine transform coefficients associated with the image is aided by using classifiers to identify an angle rotation estimate and refining the angle rotation estimate with regression. In a second example of the system, optionally including the first example in which the classifiers identify an angle rotation bin, and the regression estimates an angle bound within the angle rotation bin. In a third example of the system, optionally including one or both of the first and second examples in which the recovery of affine transform coefficients associated with the image is aided by using classifiers to identify a scale estimate and refining the scale estimate with regression. In a fourth example of the system, optionally including one or more or each of the first through third examples in which the classifiers identify a scale bin, and the regression estimates a scale bound within the scale bin. In a fifth example of the system, optionally including one or more or each of the first through fourth examples in which the recovery of affine transform coefficients associated with the image is aided by using classifiers to identify a translation estimate, and refining the translation estimate with regression. In a sixth example of the system, optionally including one or more or each of the first through fifth examples in which the classifiers identify a translation bin, and the regression estimates a translation bound within the translation bin.

The disclosure also provides support for a method comprising: receiving input imagery, processing the input imagery using a convolutional neural network (CNN) to extract image features, analyzing the extracted image features using a plurality of fully connected (FC) layers to: detect presence or absence of a digital watermark signal embedded in the input imagery, classify an image rotation angle of the input imagery into one of a plurality of angle rotation bins, and refine a rotation angle estimate within a classified angle rotation bin, determining presence of the digital watermark signal based on output of a first FC layer, determining a refined rotation angle estimate for the input imagery based on outputs of second and third FC layers, and processing the input imagery based on the refined rotation angle estimate. In a first example of the method, the plurality of FC layers further analyzes the extracted image features to: classify an image scaling factor of the input imagery into one of a plurality of scaling bins and refine a scaling factor estimate within a classified scaling bin. In a second example of the method, optionally including the first example, the method further comprises: determining a refined scaling factor estimate for the input image based on outputs of fourth and fifth FC layers. In a third example of the method, optionally including one or both of the first and second examples, classifying the image rotation angle comprises: generating, by the second FC layer, probabilities for each of the plurality of angle rotation bins, and selecting an angle rotation bin with a highest probability. In a fourth example of the method, optionally including one or more or each of the first through third examples, refining the rotation angle estimate comprises: applying, by the third FC layer, a regression model to estimate a specific rotation angle within the selected angle rotation bin. In a fifth example of the method, optionally including one or more or each of the first through fourth examples, the method further comprises: geometrically transforming the input image based on the refined rotation angle estimate to produce a transformed image and decoding the digital watermark signal from the transformed image. In a sixth example of the method, optionally including one or more or each of the first through fifth examples, the CNN comprises a feature extraction backbone including multiple convolutional layers and pooling layers. In a seventh example of the method, optionally including one or more or each of the first through sixth examples, the first FC layer employs a binary classification algorithm to detect the presence or absence of the digital watermark signal. In an eighth example of the method, optionally including one or more or each of the first through seventh examples, the second FC layer utilizes a softmax function to estimate probabilities for the plurality of angle rotation bins. In a ninth example of the method, optionally including one or more or each of the first through eighth examples, the third FC layer employs a regression model to refine the rotation angle estimate within the classified angle rotation bin.

The disclosure also provides support for a system comprising: a processor, and memory storing instructions that, when executed by the processor, cause the system to: receive input imagery, process the input imagery using a convolutional neural network (CNN) to extract image features, analyze the extracted image features using a plurality of fully connected (FC) layers to: detect presence or absence of a digital watermark signal embedded in the input imagery, classify an image rotation angle of the input imagery into one of a plurality of angle rotation bins, and refine a rotation angle estimate within a classified angle rotation bin, determine presence of the digital watermark signal based on output of a first FC layer, determine a refined rotation angle estimate for the input imagery based on outputs of second and third FC layers, and process the input imagery based on the refined rotation angle estimate. In a first example of the system, the plurality of FC layers further analyzes the extracted image features to: classify an image scaling factor of the input imagery into one of a plurality of scaling bins, and refine a scaling factor estimate within a classified scaling bin. In a second example of the system, optionally including the first example, the instructions further cause the system to: determine a refined scaling factor estimate for the input imagery based on outputs of fourth and fifth FC layers. In a third example of the system, optionally including one or both of the first and second examples, classifying the image rotation angle comprises: generating, by the second FC layer, probabilities for each of the plurality of angle rotation bins, and selecting an angle rotation bin with a highest probability. In a fourth example of the system, optionally including one or more or each of the first through third examples, refining the rotation angle estimate comprises: applying, by the third FC layer, a regression model to estimate a specific rotation angle within the selected angle rotation bin. In a fifth example of the system, optionally including one or more or each of the first through fourth examples, the instructions further cause the system to: geometrically transform the input imagery based on the refined rotation angle estimate to produce transformed imagery and decode the digital watermark signal from the transformed imagery. In a sixth example of the system, optionally including one or more or each of the first through fifth examples in which the transformed imagery comprises video or a still image. In a seventh example of the system, optionally including one or more or each of the first through sixth examples, the CNN comprises a feature extraction backbone including multiple convolutional layers and pooling layers. In an eighth example of the system, optionally including one or more or each of the first through seventh examples, the first FC layer employs a binary classification algorithm to detect the presence or absence of the digital watermark signal. In a ninth example of the system, optionally including one or more or each of the first through eighth examples, the second FC layer utilizes a softmax function to estimate probabilities for the plurality of angle rotation bins. In a tenth example of the system, optionally including one or more or each of the first through ninth examples, the third FC layer employs a regression model to refine the rotation angle estimate within the classified angle rotation bin.

The disclosure also provides support for a non-transitory computer-readable medium storing instructions that, when executed by a processor, cause the processor to perform operations comprising: receiving input imagery, processing the input imagery using a convolutional neural network (CNN) to extract image features, analyzing the extracted image features using a plurality of fully connected (FC) layers to: detect presence or absence of a digital watermark signal embedded in the input imagery, classify an image rotation angle of the input imagery into one of a plurality of angle rotation bins, and refine a rotation angle estimate within a classified angle rotation bin, determining presence of the digital watermark signal based on output of a first FC layer, determining a refined rotation angle estimate for the input imagery based on outputs of second and third FC layers, and processing the input imagery based on the refined rotation angle estimate. In a first example of the system, the plurality of FC layers further analyze the extracted image features to: classify an image scaling factor of the input image into one of a plurality of scaling bins, and refine a scaling factor estimate within a classified scaling bin. In a second example of the system, optionally including the first example, the operations further comprise: determining a refined scaling factor estimate for the input imagery based on outputs of fourth and fifth FC layers. In a third example of the system, optionally including one or both of the first and second examples, classifying the image rotation angle comprises: generating, by the second FC layer, probabilities for each of the plurality of angle rotation bins, and selecting an angle rotation bin with a highest probability. In a fourth example of the system, optionally including one or more or each of the first through third examples, refining the rotation angle estimate comprises: applying, by the third FC layer, a regression model to estimate a specific rotation angle within the selected angle rotation bin. In a fifth example of the system, optionally including one or more or each of the first through fourth examples, the operations further comprise: geometrically transforming the input imagery based on the refined rotation angle estimate to produce transformed imagery and decoding the digital watermark signal from the transformed imagery. In a sixth example of the system, optionally including one or more or each of the first through fifth examples, the transformed imagery comprises video or a still image. In a seventh example of the system, optionally including one or more or each of the first through sixth examples, the CNN comprises a feature extraction backbone including multiple convolutional layers and pooling layers. In an eighth example of the system, optionally including one or more or each of the first through seventh examples, the first FC layer employs a binary classification algorithm to detect the presence or absence of the digital watermark signal. In a ninth example of the system, optionally including one or more or each of the first through eighth examples, the second FC layer utilizes a softmax function to estimate probabilities for the plurality of angle rotation bins. In a tenth example of the system, optionally including one or more or each of the first through ninth examples, the third FC layer employs a regression model to refine the rotation angle estimate within the classified angle rotation bin.

The disclosure also provides support for a method comprising: receiving input imagery, processing the input imagery using a convolutional neural network (CNN) to extract image features, analyzing the extracted image features using a plurality of fully connected (FC) layers to: detect presence or absence of a digital watermark signal embedded in the input imagery, classify an image rotation angle of the input imagery into one of a plurality of angle rotation bins, refine a rotation angle estimate within a classified angle rotation bin, classify an image scaling factor of the input image into one of a plurality of scaling bins, and refine a scaling factor estimate within a classified scaling bin, determining presence of the digital watermark signal based on output of a first FC layer, determining a refined rotation angle estimate for the input image based on outputs of second and third FC layers, determining a refined scaling factor estimate for the input imagery based on outputs of fourth and fifth FC layers, and processing the input imagery based on the refined rotation angle estimate and the refined scaling factor estimate. In a first example of the method, the method further comprises: geometrically transforming the input imagery based on the refined rotation angle estimate and the refined scaling factor estimate to produce transformed imagery, and decoding the digital watermark signal from the transformed imagery.

The disclosure also provides support for a system for image analysis, comprising: means for receiving input imagery, means for extracting image features from the input imagery, means for detecting presence or absence of a digital watermark signal embedded in the input imagery based on the extracted image features, means for classifying an image rotation angle of the input image into one of a plurality of angle rotation bins, means for refining a rotation angle estimate within a classified angle rotation bin, means for classifying an image scaling factor of the input image into one of a plurality of scaling bins, means for refining a scaling factor estimate within a classified scaling bin, and means for processing the input imagery based on the refined rotation angle estimate and the refined scaling factor estimate. In a first example of the system, the means for extracting image features comprises a convolutional neural network (CNN) including multiple convolutional layers and pooling layers. In a second example of the system, optionally including the first example, the means for detecting presence or absence of a digital watermark signal comprises a fully connected layer employing a binary classification algorithm. In a third example of the system, optionally including one or both of the first and second examples, the means for classifying an image rotation angle comprises a fully connected layer utilizing a softmax function to estimate probabilities for each of the plurality of angle rotation bins. In a fourth example of the system, optionally including one or more or each of the first through third examples, the means for refining a rotation angle estimate comprises a fully connected layer employing a regression model to estimate a specific rotation angle within the classified angle rotation bin. In a fifth example of the system, optionally including one or more or each of the first through fourth examples, the means for classifying an image scaling factor comprises a fully connected layer utilizing a softmax function to estimate probabilities for each of the plurality of scaling bins. In a sixth example of the system, optionally including one or more or each of the first through fifth examples, the means for refining a scaling factor estimate comprises a fully connected layer employing a regression model to estimate a specific scaling factor within the classified scaling bin. In a seventh example of the system, optionally including one or more or each of the first through sixth examples, the system further comprises: means for geometrically transforming the input imagery based on the refined rotation angle estimate and the refined scaling factor estimate to produce transformed imagery, and means for decoding the digital watermark signal from the transformed imagery. In an eighth example of the system, optionally including one or more or each of the first through seventh examples in which the transformed imagery comprise video or a still image. In a ninth example of the system, optionally including one or more or each of the first through eighth examples, the means for classifying an image rotation angle and the means for classifying an image scaling factor utilize a Kullback-Leibler divergence loss function during training. In a tenth example of the system, optionally including one or more or each of the first through ninth examples, the means for refining a rotation angle estimate and the means for refining a scaling factor estimate utilize a mean squared error loss function during training. In a eleventh example of the system, optionally including one or more or each of the first through tenth examples in which the input imagery comprises video or a still image.

The foregoing and other aspects and details of the applicant's work will be more readily apparent from the following detailed description, which proceeds with reference to the accompanying drawings.

### BRIEF DESCRIPTION OF THE DRAWINGS

FIG. 1A is an image of a mountain landscape; FIG. 1B is a rotated version of the image depicted in FIG. 1A; and FIG. 1C is a cropped and scaled version of the image depicted in FIG. 1A.

FIG. 2 is a graph showing watermark capacity per transformation distortion at the same visibility.

FIG. 3A is a system to resolve image and video affine transformations using regression; and FIG. 3B is a system diagram for DeepSync, a technology that can resolve image and video affine transformations, e.g., in an image processing environment (e.g., digital watermarking), using classification and regression.

FIG. 4 shows use of multiple angle estimate classification+regression within DeepSync.

FIG. 5 is a flow diagram of a neural network training process.

FIG. 6 is a flow diagram showing image preparation for an input to the FIG. 5 neural network training process.

FIG. 7 is a flow diagram of an affine transform recovery method.

FIG. 8 are plots of an output instance of FC2 (top) N_{θ} angle estimates and corresponding output of FC3 (bottom).

FIG. 9 are plots of an output instance of FC4 (top) Nₛ scaling coefficient estimates and corresponding output of FC5 (bottom).

FIG. 10 are histograms of estimated rotation and scaling factors obtained from 20,000 watermarked image blocks (left) rotated by 75° and scaled by 0.4, (right) rotated by −56° and scaled by 0.65.

FIG. 11 is a graph showing plot for different implementations of the FIG. 3B system with varying regressors/classifier bins.

FIG. 12 is a graph showing detection DeepSync results in a HiDDen [1] implementation.

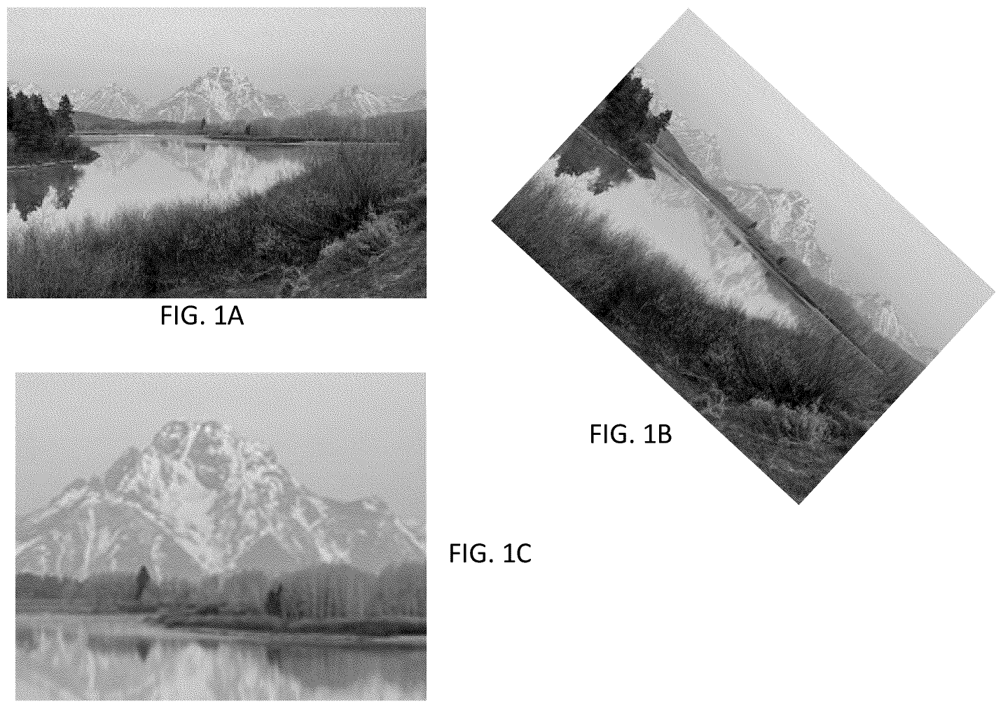

Additional drawings are found in the attached Appendix A, which is hereby incorporated herein by reference in its entirety and expressly forms part of the written description of this specification.

### DETAILED DESCRIPTION

A number of arrangements involving CNN-based networks are described below. The following section heading are provided merely for reader convenience. Features under one such section heading are intended to be readily combined with features from another such section heading.

### DeepSync—Synchronization for Deep AI and Traditional-Based Watermarking Systems

In the context of digital image/video watermarking, addressing a problem of synchronization with Convolutional Neural Networks (CNNs) has traditionally posed challenges. The problem is particularly challenging for affine transforms such as rotation, scaling, and/or translation. Recovering affine transforms via CNN-based regression often results in subpar performance. In the below description we illustrate technology to recover embedded data in the presence of affine transforms via CNN-based classification and regression with high accuracy. (While the discussion, below, focusses on imagery, which may include video, the technology is readily available for audio as well.)

We understand current deep watermarking techniques (e.g., AI based watermarking systems) lack precise recovery of geometric transformation for practical systems. For example, a review of literature indicates that many deep watermarking techniques face a tradeoff between capacity vs. visibility when encountering affine transformations. See Table 1, below:

TABLE 1

| Prior Work | Embedding | Extraction | Robust to: |
|---|---|---|---|
| [1] HiDDen | CNN-Based | Transform Invariant | Transforms |
| | | | seen in training |
| [2] RoSteALS | CNN-Based | Transform Invariant | Transforms |
| | | | seen in training |
| [3] Stable | CNN-Based | Transform Invariant | Transforms |
| Signature | | | seen in training |
| [4] TrustMark | CNN-Based | Transform Invariant | Transforms |
| | | | seen in training |
| [5] Distortion | CNN-Based | Transform Invariant | Transform |
| Agnostic | | | agnostic; |
| Watermarking | | | adversarial |
| | | | learning |
| [6] ReSWAT | Gradient- | Transform Invariant | Transforms |
| | Based | | seen in training |
| [7] SSL | Gradient- | Transform Invariant | Transforms seen |
| | Based | | in embedding |
| [8] LECA | Alpha- | Synchronization by | Transforms |
| | blending | pattern matching | seen in training |
| | with CNN- | | |
| | Basedtemplate | | |

[1]F. Zhu et al., “Hidden: Hiding Data with Deep Networks,” Proc. ECCV, pp. 657-672, (2018). [2]T. Bui et al., “RoSteALS: Robust Steganography using Autoencoder Latent Space,” Proc. IEEE CVPR, pp. 933-942, (2023). [3]P. Fernandez et al., “The Stable Signature: Rooting Watermarks in Latent Diffusion Models,” IEEE ICCV, (2023). [4]T. Bui et al., “TrustMark: Universal Watermarking for Arbitrary Resolution Images,” arXiv preprint arXiv:2311.18297, (2023) [5]X. Luo et al., “Distortion Agnostic Deep Watermarking,” IEEE CVPR, (2020). [6]J. Hayes et al., “Towards transformation-resilient provenance detection of digital media,” https://arxiv.org/abs/2011.07355v1, (2020). [7]P. Fernandez et al., “Watermarking Images in Self-Supervised Latent Spaces,” IEEE ICASSP, (2022). [8]X. Luo et al., “LECA: A Learned Approach for Efficient Cover-Agnostic Watermarking,” Electronic Imaging, (2023). Each of the documents in this paragraph are incorporated herein by reference in their entirety.

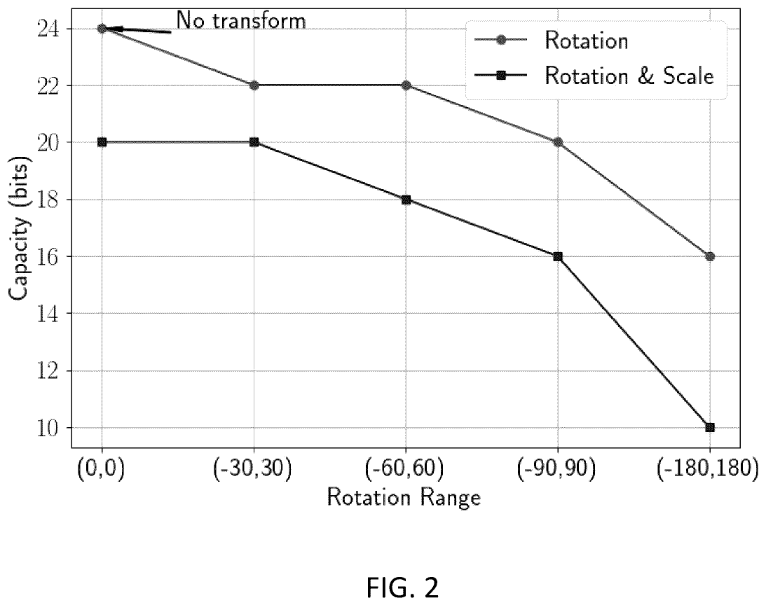

Indeed, our experimentation shows that AI-learned transform invariance risks payload capacity. Such a reduction in payload capacity threatens viability for large scale commercial deployments that may require digital watermarks to survive transforms (e.g., rotation, scale, translation). Reduced payload capacity can lead to an increase in false positives as well, e.g., a death-knell for anti-counterfeiting systems. In one study, we trained variants of the above HiDDeN [1] AI models on the COCO2017 [2] dataset with rotation, and/or scaling transforms. As shown in FIG. 2, increasing transform severity, at same watermark visibility, leads to a loss in payload bit capacity. The Y-axis shown in FIG. 2 is the rotation angle in degrees from (0,0) to (−180, 180); the X-axis in the number of bits from 10-24. (We used a bit number per transform to be at a threshold of being able to recover message bits with less than 2% error.)

To provide technical solutions for these problems, we now describe our DeepSync technology, a deep learning system providing image synchronization (e.g., estimation of rotation, scale and/or translation) that can be used after watermark embedding and before watermark detection. DeepSync can estimate image affine transforms to allow for inversion (e.g., rotate and scale) prior to watermark detection. DeepSync is applicable to traditional watermarking systems (e.g., based on implicit and explicit synchronization signals, see discussion below) and AI-based deep watermarking system.

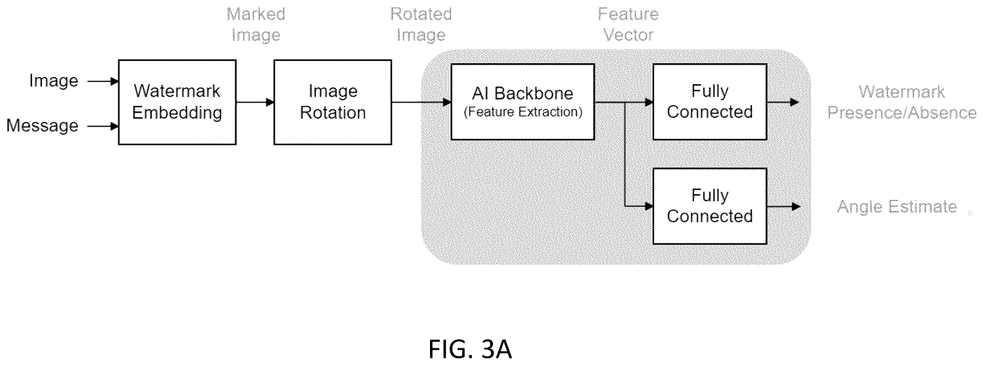

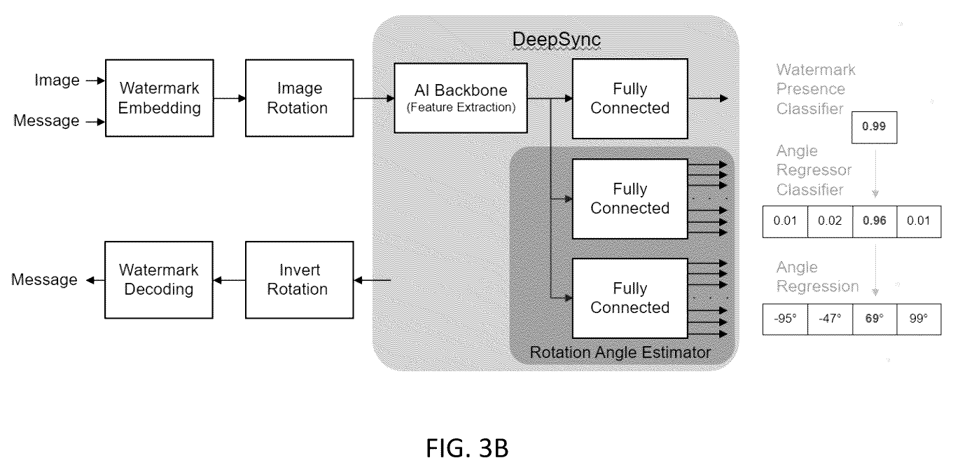

One embodiment of a DeepSync system is described with reference to FIG. 3B.

For environmental context, an image (or video) is input into a digital watermark embedder. The watermark embedding can be carried out in a spatial domain, frequency domain (e.g., FFT, DCT), or can be facilitated through deep (AI-based) watermarking, CNN-based, or other types of digital watermark embedding. Indeed, DeepSync may be able to increase message capacity at the same visibility with a variety of digital watermark embedding/detection technologies. The embedded image (e.g., the input image after digital watermark embedding) next experiences affine transformation (e.g., rotation, scaling, and/or translation). While FIG. 3B shows image “Rotation”, the system is adaptable for scaling and translation as well.

The DeepSync system includes a feature extraction module and a plurality of fully connected layers. The image is given as input to the feature extraction, e.g., a so-called backbone/Feature Extractor Network such as, e.g., EfficientNet, ResNet, MobileNet, VGGNet, or other feature extracting neural network. The Backbone network outputs a feature vector, e.g., a length-L feature vector f∈ [symbol] ^{L×1} Of course, instead of a single Backbone, we predict that multiple [symbol] different backbone networks can be used. For example, a first backbone extracts features that are suitable for estimating angle rotation. A second backbone extracts features that are suitable for estimating scale and/or translation.

The feature vector f is then provided as input to the plurality of Fully Connected (FC) layers (e.g., detection heads), each serving a task of interest. The illustrated system shows 3 FC layers; however, we anticipate that variations of system will include many more. Illustrated FC layers include a watermark presence classifier, an angle regressor classifier and an angle regression layer. Other anticipated (but not illustrated) FC layers may include, e.g., a scale classifier layer, a scale regression layer, a translation classifier layer, a translation regression layer, a differential-scale classifier layer, and a differential scale regression layer.

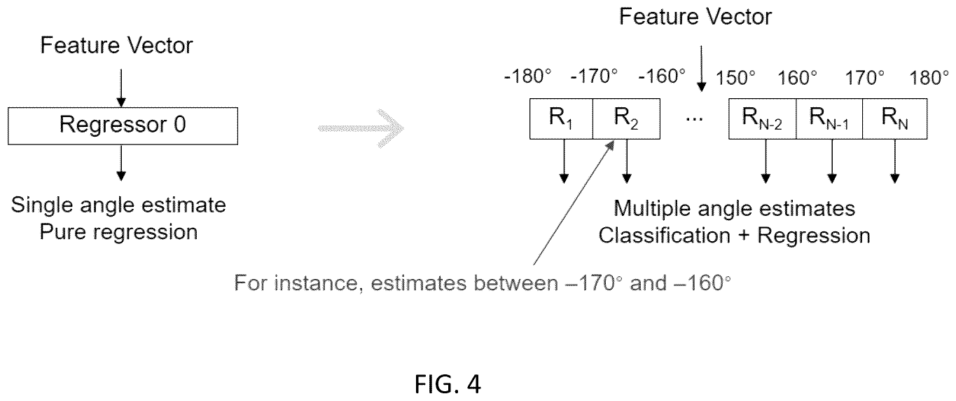

With reference to FIGS. 3A and 4, we decided to move away from a single angle estimate (e.g., pure regression) toward multiple angle rotation estimates with the introduction of multiple angle rotation classifier bins, with regression for each bin. This decision was based, in part, on our current understanding that pure regression exhibits non-satisfactory performance; and performance appears to worsen as more attacks are introduced (e.g., more rotation and scaling). So we divided a single regression problem into smaller and easier sub-problems.

In one example, we include a plurality of angle estimate classification bins or classes, R₁-R_{N}. Each of these bins or classes represent an estimate angle rotation range, e.g., between 0-10 degrees, or between −170 degrees and −160 degrees (e.g., R₂ in FIG. 4), at 10-degree intervals. Of course, the bins could be trained to have a more course angle estimate (e.g., each having a range of 60 degrees) or more fine angle rotation estimate (e.g., each bin having a range of 1-5 degrees). We currently predict that between 10-200 bins will yield accurate results. For example, 10-20 bins, or 10-40 bins, or between 10-50 bins, or between 100-200 bins, will yield a sufficient result. Sufficiency here can be viewed in terms of an acceptable error rate, e.g., plus or minus 1-5 rotation degrees (or scale error and/or translation error). The output of the angle classifier FC layer identifies a bin or class predicted to align with the angle rotation of the embedded image. In one implementation, the output comprises a Probability Mass Function (PMF) providing a probability associated with each bin; in another implementation, the output comprises a set of probabilities or confidences that are associated with each bin. In the FIG. 3B example, four probabilities/confidences are output, each respectively corresponding to a bin 1-4: [0.01, 0.02, 0.96, 0.01]. This output indicates that estimated angle rotation of the embedded image falls within the 3^{rd} bin with a high confidence of 0.96.

The Angle Regression FC layer comprises a plurality of regressors, one for each of the plurality of bins. The output of the Angle Regression FC Layer predicts a specific rotation angle for the associated bin range. In the FIG. 3B example, regression predicts that 69 degrees (the Bin 3 regressor) is the rotation angle associated with the embedded image. In this way, the range within a selected bin is refined using regression. (While regressed angles predictions maybe produced by the Angle Regression FC layer for other, non-selected bins (e.g., Bin 1=−95 degrees, Bin 2=−47 degrees, Bin 4=99 degrees, the regressor associated with the selected bin, here Bin 3, is of interest.)

Of course, while not shown, DeepSync can include Fully Connected layers to predict scale and/or translation. We approach these affine transformations in a similar manner. For example, we utilize a FC layer as a classifier to determine between a plurality of scale estimate bins, e.g., between 5-50 bins bound between 0.1×-5×, more preferably between 0.5×-2×. For example, the number of scale estimate bins may include between 5-10, 5-20, or even 5-50 bins.

Returning to FIG. 3B, once the rotation angle is predicted, e.g., 69 degrees, the embedded image can be rotated by −69 degrees to remove the estimated rotation angle (and/or scale and translation) prior to watermark decoding.

Now consider an example training methodology. Image pre-processing resizes a training image to a minimum dimension n×n (where n is a positive integer); and then a random crop of size m×m (where m is a positive integer, m<n). For example, n=384 pixels, and m=128 pixels. We provide supervised labels or so-called “supervision signals”. For the watermark present classifier (watermark label is 0 or 1), for the watermark presence classification FC layer random angle bound between (−180°, 180°), angle regression/classification FC layer (e.g., one-hot vector [0,0,1,0,0], where the 1 indicates the third bin is present; and random scale in (0.5×, 2×), e.g., a one-hot vector with a 1 for that bin's scaling.

Loss functions are determined using various functions, e.g., for watermark presence (use, e.g., Binary Cross Entropy with output logits), and for Angle Rotation/Scale Classification (use, e.g., Softmax+Cross Entropy) and for Angle Rotation/Scale Regression (use, e.g., Sigmoid+Mean Squared Error or Mean Absolute Error). Of course, implementation details from the below sub-section “DeepSync Examples addressing Image Template Synchronization” can be used in this section as well, and vice versa.

### DeepSync Examples Addressing Image Template Synchronization

Now consider some specific examples of DeepSync implementations addressing problems of image template synchronization with Convolutional Neural Networks (CNNs). In the below description we show that it is possible to address image template synchronization in the presence of affine transforms via CNN-based regression with high accuracy. (While the discussion, below, focusses on imagery (which may include video), the technology is readily available for audio as well.)

We use the term “image template” here to mean an expected or observed image pattern or arrangement. One example of an image template is an expected distortion pattern, e.g., image blur, scaling, rotation, as may be expected in some scan and print channels or in some social networking platforms. Another example of an image template is an expected shape, e.g., circles, plus signs (“+”), farm fields, city blocks, and/or trees on a hill. Still another example of an image template is a predefined pattern (or “template”) that is overlaid onto digital content followed by visual masking. One example of an image template includes, e.g., an explicit or implicit digital watermark synchronization signal. An explicit synchronization signal may include an auxiliary signal that is separate from an encoded payload. An implicit synchronization signal may include a signal formed with an encoded payload, giving it structure that facilitates geometric/temporal synchronization. Examples of explicit and implicit synchronization signals are provided in our U.S. Pat. Nos. 6,614,914, and 5,862,260, which are each hereby incorporated herein by reference in their entirety. There are many types of synchronization components that may be used with the present technology.

For example, a synchronization signal may be comprised of elements that form a circle in a particular domain, such as the spatial image domain, the spatial frequency domain, or some other transform domain. Assignee's U.S. Pat. No. 7,986,807, which is hereby incorporated herein by reference in its entirety, considers a case, e.g., where the elements are impulse or delta functions in the Fourier magnitude domain. The reference signal comprises impulse functions located at points on a circle centered at the origin of the Fourier transform magnitude. These create or correspond to frequency peaks. The points are randomly scattered along the circle, while preserving conjugate symmetry of the Fourier transform. The magnitudes of the points are determined by visibility and detection considerations. To obscure these points in the spatial domain and facilitate detection, they have known pseudorandom phase with respect to each other. The pseudorandom phase is designed to minimize visibility in the spatial domain. In this circle reference pattern example, the definition of the reference pattern only specifies that the points should lie on a circle in the Fourier magnitude domain. The choice of the radius of the circle and the distribution of the points along the circle can be application specific. For example, in applications dealing with high resolution images, the radius can be chosen to be large such that points are in higher frequencies and visibility in the spatial domain is low. For a typical application, the radius could be in the mid-frequency range to achieve a balance between visibility requirements and signal-to-noise ratio considerations.

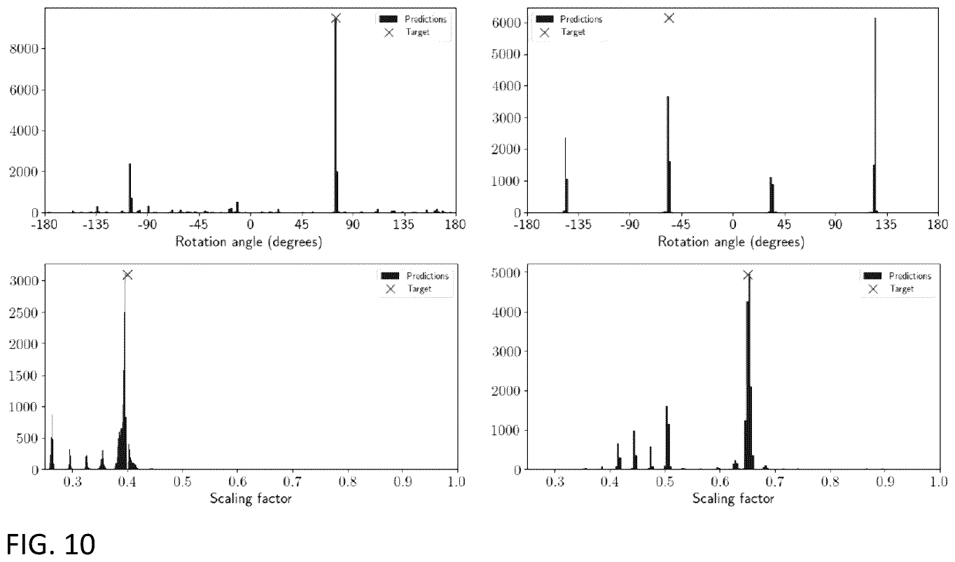

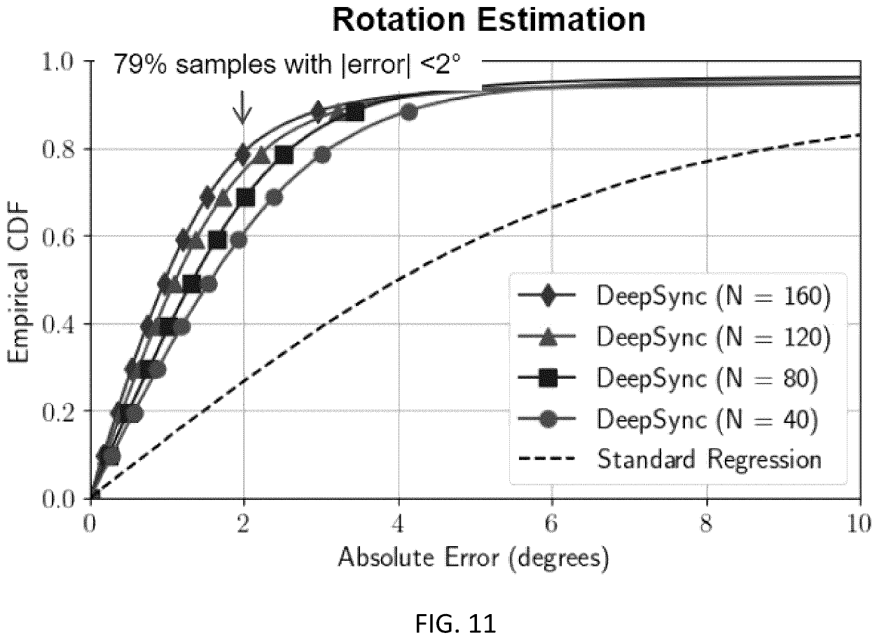

Another example is found in Assignee's U.S. Pat. No. 6,614,914, which is hereby incorporated herein by reference in its entirety. There, a synchronization component (or “orientation pattern”) can be comprised of a pattern of quad symmetric impulse functions in the spatial frequency domain. These create or correspond to frequency peaks. In the spatial domain, these impulse functions may look like cosine waves. An example of an orientation pattern is depicted in FIGS. 10 and 11 of the '914 patent.

Another type of synchronization component may include a so-called Frequency Shift Keying (FSK) signal. For example, in Assignee's U.S. Pat. No. 6,625,297, which is hereby incorporated herein by reference in its entirety, a watermarking method converts a watermark message component into a self-orienting watermark signal and embeds the watermark signal in a host signal (e.g., imagery, including still images and video). The spectral properties of the FSK watermark signal facilitate its detection, even in applications where the watermarked signal is corrupted. In particular, a watermark message (perhaps including CRC bits) can be error corrected, and then spread spectrum modulated (e.g., spreading the raw bits into a number of chips) over a pseudorandom carrier signal by, e.g., taking the XOR of the bit value with each value in the pseudorandom carrier. Next, an FSK modulator may convert the spread spectrum signal into an FSK signal. For example, the FSK modulator may use 2-FSK with continuous phase: a first frequency represents a zero; and a second frequency represents a one. The FSK modulated signal can be applied to rows and columns of a host image. Each binary value in the input signal corresponds to a contiguous string of at least two samples in a row or column of the host image. Each of the two frequencies, therefore, is at most half the sampling rate of the image. For example, the higher frequency may be set at half the sampling rate, and the lower frequency may be half the higher frequency. When FSK signaling is applied to the rows and columns, the FFT magnitude of pure cosine waves at the signaling frequencies produces grid points or peaks along the vertical and horizontal axes in a two-dimensional frequency spectrum. If different signaling frequencies are used for the rows and columns, these grid points will fall at different distances from the origin. These grid points, therefore, may form a detection pattern that helps identify the rotation angle of the watermark in a suspect signal. Also, if an image has been rotated or scaled, the FFT of this image will have a different frequency spectrum than the original image. For detection, a watermark detector can transform the host imagery to another domain (e.g., a spatial frequency domain), and then performs a series of correlation or other detection operations. The correlation operations match the reference pattern with the target image data to detect the presence of the watermark and its orientation parameters.

Yet another synchronization component is described in assignee's U.S. Pat. No. 7,046,819, which is hereby incorporated by reference in its entirety. There, a reference signal with coefficients of a desired magnitude is provided in an encoded domain. These coefficients initially have zero phase. The reference signal is transformed from the encoded domain to a first transform domain to recreate the magnitudes in the first transform domain. Selected coefficients may act as carriers of a multi-bit message. For example, is an element in the multi-bit message (or an encoded, spread version of such) is a binary 1, a watermark embedder creates a peak at the corresponding coefficient location in the encoded domain. Otherwise, the embedder makes no peak at the corresponding coefficient location. Some of the coefficients may always be set to a binary 1 to assist in detecting the reference signal. Next, the embedder may assign a pseudorandom phase to the magnitudes of the coefficients of the reference signal in the first transform domain. The phase of each coefficient can be generated by using a key number as a seed to a pseudorandom number generator, which in turn produces a phase value. Alternatively, the pseudorandom phase values may be computed by modulating a PN sequence with an N-bit binary message. With the magnitude and phase of the reference signal defined in the first transform domain, the embedder may transform the reference signal from the first domain to the perceptual domain, which for images, is the spatial domain. Finally, the embedder transforms the host image according to the reference signal.

More recently, significant research effort has focused on employing artificial intelligence methods for advancing watermarking techniques. For example, please see the above incorporated-by-reference patent documents including: US20210357690A1, US20220270199A1, 11,704,765, and 11,194,984.

One objective of a successful watermarking framework is to balance three factors, e.g.: Perceptual Similarity, Robustness and Capacity. Perceptual Similarity—a watermarking process preferably embeds a message into imagery or audio while causing minimal perceptual changes to the original content. Maintaining perceptual similarity ensures that the watermarked imagery or audio remains minimally indistinguishable from the original, allowing for user acceptance and satisfaction. Robustness—in the face of image distortions, compression, or other common forms of image workflows/attacks, the digital watermark preferably exhibits resilience. An embedded message (e.g., a plural-bit message) should be recoverable even after these transformations, allowing for reliable information retrieval in real-world scenarios. Capacity—to maximize utility, watermarking systems aim to achieve the highest possible message length relative to image size or audio length. This capacity factor enables the embedding of information within imagery or audio, facilitating various applications such as data hiding, annotation, and content identification/provenance.

One aspect of this disclosure is to improve recovering image template affine transforms via CNN-based classification and regression. For example, we describe technology to determine robustness of image template matching with respect to affine image distortions such as rotation, scaling, and translation. In one example, we propose a reformulation of a problem which enables successful detection of a presence/absence of a digital watermark and recovery of affine transform coefficients associated with an image template (e.g., a synchronization signal). Estimating and inverting affine transform before extracting payload provides advantages as payload bits do not need to survive transformations that can be inverted.

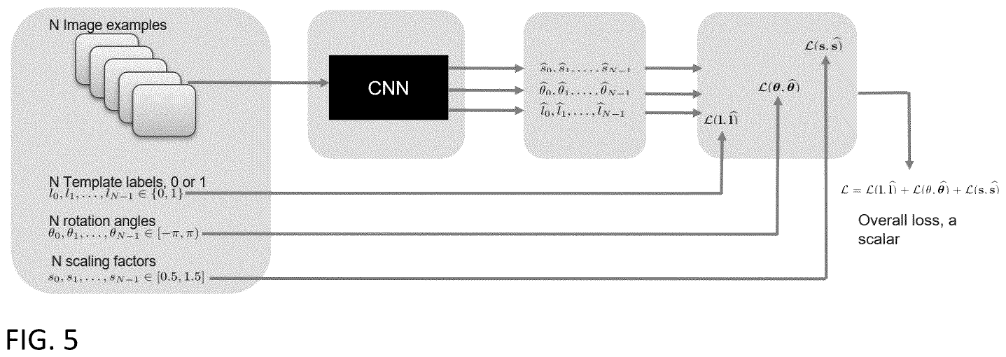

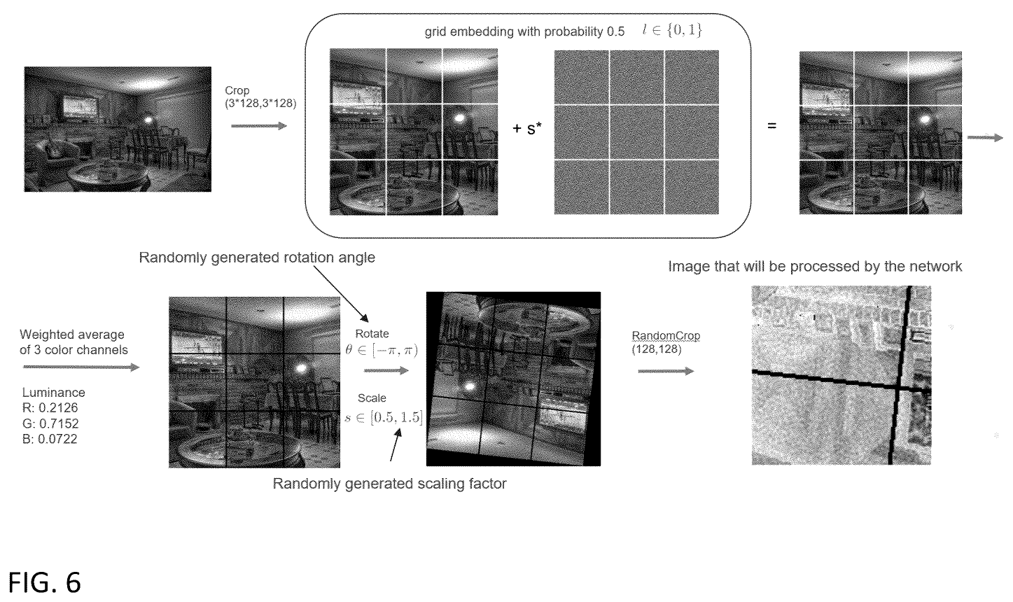

Training of a neural network to: i) detect a presence/absence of an encoded signal; and ii) determine affine parameters (e.g., rotation and scale, and optionally, translation and differential scale) of a present encoded signal, is described further with respect to FIGS. 5 and 6. In FIG. 5, N image examples are provided for training, where N is a positive integer. For each image N, label information is provided, e.g., as a quartet: Image (N), Image Template label (Template presence indicator, e.g., present (1) or absence (0)), Rotation angle (between −π and π), and Scaling factor (between 0.1×-10×, or more preferably, between 0.1×-5.0×, and even more preferably, between 0.5×-1.5×). The quartet for each image N is provided to a neural network (e.g., a CNN) for training. The training yields a loss function as shown in FIG. 5.

Additional image preparation details are provided with respect to FIG. 6. An image is provided for training. The image is cropped and formatted according to training input parameters or image template parameters. For example, the image is cropped and segmented into 3×3 blocks, with each block comprising 128×128 pixels. This pixel size can be changed, of course, e.g., depending on neural network input setup or image templates used, e.g., 16×16, 64×64, 256×256 or even other non-rectangularly shaped blocks. The cropped image is combined (or not, e.g., with a 0.5 chance of embedding probability) with redundant instances (as pictured, 9 instances) of an image template (also called “grid”). As pictured, the image template includes a digital watermark signal including a synchronization component. In some cases, the synchronization component is combined with or forms a message component. One example of an image template is a zero-mean spread spectrum digital watermark image template such as in FIG. 4 (“watermark tile”) of A. Reed, T. Filler, K. Falkenstern, and Y. Bai, Watermarking spot colors in packaging, Proc. Media Watermarking, Security, and Forensics, pp. 46-58, (2015), which is hereby incorporated herein by reference in its entirety. Other suitable synchronization components for use as image templates are discussed above. The embedded image N is converted to luminance, and then randomly rotated (between −π and π) and scaled (between 0.5 and 1.5). The rotated and scaled image is then cropped, e.g., to a 128×128 pixel block, which is used as an input image N for neural network training (e.g., as shown in FIG. 5). In one embodiment (not shown in FIG. 6), the original image or the cropped 3×3 image is randomly rotated and/or scaled prior to image template combination.

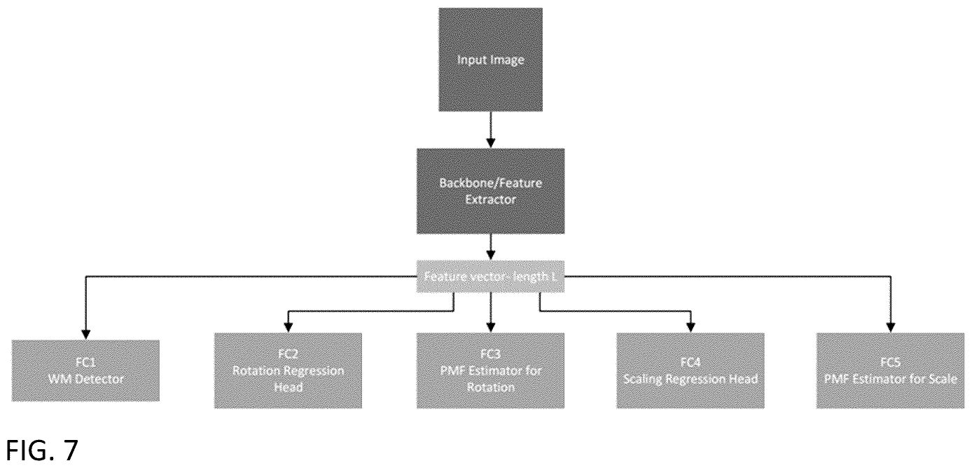

In order to: (i) detect presence/absence of the digital watermark template signal, (ii) extract a rotation coefficient, and (iii) extract a scaling coefficient, we use a CNN backbone as a shared feature extractor. If the digital watermark template signal is detected, then the same features can be used for classification and regression of rotation and scaling coefficients (thus, “shared”). Regression of these transform via CNNs has been challenging in the past. With reference to FIG. 7, consider an input image of X∈ [symbol] ^{H×W} where H and W denote the height and width of the input image, respectively. The image is given as input to a Backbone/Feature Extractor Network, e.g., EfficientNet, ResNet, MobileNet, VGGNet, or other feature extracting neural network. The Backbone network outputs a length-L feature vector f∈ [symbol] ^{L×1}. The feature vector f is then provided as input to multiple Fully Connected (FC) layers (e.g., detection heads), each serving a task of interest. Detection heads include, e.g., FC1 (image template or watermark presence detector), FC2 (Rotation Regression), FC3 (Rotation Bin Estimator); FC4 (Scaling Regression head) and FC5 (Scale Bin Estimator).

A Fully Connected layer can, in general, be described as the following operation:

$$y = Wx + b ,$$

where x∈ [symbol] ^{l×1} is the input vector (l is the number of input features), W∈ [symbol] ^{k×l} is the weights matrix that is learnable (k in the number of output features), and b∈ [symbol] ^{k×1} is the bias vector that is also learnable. The bias term is optional and can be disabled.

### FC1—Image Template Detector

This layer is responsible for detecting presence (or, absence) of an image template, e.g., an embedded watermark signal. The number of input features is L and the number of output features is 1. Mathematically, FC1 can be described as

$${y}_{1} = {W}_{1} f + {b}_{1} ,$$

where W₁∈ [symbol] ^{1×L} and b₁∈ [symbol] are the learned weight matrix and bias term, respectively. The output y is a real number in general, it may be positive or negative and its magnitude has no explicit bounds. To be able to make a decision with respect to presence/absence of image template, we can apply a sigmoid function to y in order to get a number that is bounded between 0 and 1.

When we combine FC1 with a sigmoid function, the output we get is:

$${y}_{1}^{′} = σ ( {y}_{1} ) = σ ( {W}_{1} f + {b}_{1} ) ∈ [ 0 , 1 ] .$$

Let τ∈(0,1) be a threshold based on which we decide for presence or absence of the watermark. Then, the classification decision takes the form:

$${y}_{1}^{′} {\begin{matrix}< \\ >\end{matrix}}_{Presence}^{Absence} τ .$$

The sigmoid function, denoted by σ(x), is an activation function in machine learning and neural networks. It is defined as

$$σ ( x ) = \frac{1}{1 + {e}^{- x}} ,$$

where e is the base of the natural logarithm. The sigmoid function maps any real-valued number to the range of [0, 1], making it particularly useful in tasks where the output is to be interpreted as a probability. As the input x approaches positive infinity, the sigmoid function asymptotically approaches 1, while as x approaches negative infinity, the sigmoid function approaches 0. This characteristic makes it well-suited for binary classification problems.

### FC2—Rotation Bin Regression

This layer is responsible for rotation angle regression (e.g., a refinement layer). Before we review the algorithms behind FC2, we establish notation that will enhance legibility.

We consider that the number of regression bins is N_{θ}. This number is a user-defined parameter selected at design time. It then follows that the width of each bin is:

$${θ}_{step} = \frac{{θ}_{max} - {θ}_{min}}{{N}_{θ}} .$$

Finally, we also know the bounds of each regressor bin. That is, the 1≤i≤N_{θ}-th bin regressor [symbol] _{θ}⁽ⁱ⁾ will be responsible for estimating angles in

$$[ {θ}_{min} + ( i - 1 ) {θ}_{step} , {θ}_{min} + i {θ}_{step} ) .$$

If we concatenate the minimum bounds of each bin in a vector we get

$$w = {[ {θ}_{min} , {θ}_{min} + {θ}_{step} , … , {θ}_{max} - {θ}_{step} ]}^{⊤} .$$

The number of input features is L and the number of output features is NB. FC2 can be described as:

$${y}_{2} = {W}_{2} f + {b}_{2} ∈ {ℝ}^{{N}_{θ} \times 1} ,$$

where W₂∈ [symbol] ^{N}^{_{θ}}^{×L} and b₂∈ [symbol] ^{N}^{_{θ}}^{×1} are the learned weight matrix and bias terms, respectively. As before, the outputs in y₂ are real numbers with no explicit bounds. To convert them to rotation angle estimates we work as follows. First, we compute:

$${y}_{2}^{′} = σ ( {y}_{2} ) .$$

Here, the sigmoid function was applied elementwise, therefore, entries in y′₂ are bounded in [0,1]. Then, we leverage the minimum bounds of each bin, w, and obtain estimates:

$$\hat{θ} = w + {y}_{2}^{′} ⊙ {θ}_{step} ∈ {ℝ}^{{N}_{θ} \times 1} ,$$

where ‘⊙’ denotes the element-wise product operation. Vector \hat{θ} comprises the refined rotation angle estimates, one per bin. FC3 will help us select which of the estimates to retain.

### FC3—Classification for Rotation

Since we have multiple rotation angles estimates, we devised a way to decide which estimate is best (e.g., best in terms of highest confidence or highest probabilities). We use a plurality of rotation angle bins (or classifications), with each bin representing a different rotation angle range, and predict which bin corresponds to a particular rotation angle estimate. Consider, for example, that an input image was rotated by an angle that belongs, e.g., in the second bin. This can be modeled as a one-hot encoding or as a Probability Mass Function (PMF). That is, the ground truth we would use to train FC3 would be of the form:

$$∈ {ℝ}^{{N}_{θ} \times 1} ,$$

The above is a one-hot encoding informing us that the angle of interest belongs in the second bin. The above also conforms to the definition of a PMF. Following this modeling, we train FC3 such that it outputs a PMF that we can use to decide at which bin to look at for the best angle estimate (e.g., best in terms of highest confidence or highest probabilities).

Mathematically, FC3 can be described as follows. The number of input features is L and
the number of output features is No. We obtain:

$${y}_{3} = {W}_{3} f + {b}_{3} ∈ {ℝ}^{{N}_{θ} \times 1} ,$$

where W₃∈ [symbol] ^{N}^{_{θ}}^{×L} and b₃∈ [symbol] ^{N}^{_{θ×1}} are the learned weight matrix and bias terms, respectively. As before, the outputs in y₃ are real numbers with no explicit bounds. This time, we want to bound these numbers in [0,1] but at the same time they preferably sum up to 1 such that the output conforms to a PMF definition. To accomplish this, we use the Softmax function and obtain:

$${y}_{3}^{′} = softmax ( {y}_{3} ) .$$

y′₃ is a PMF. The index of the entry with maximum value of y′₃ informs us about the bin that we should look at to retrieve the estimated angle estimate. In view of this, we can think of this approach as a classification followed by a refinement step, e.g., FC3 does the classification and FC2 does the refinement.

The softmax function is defined as follows: For a vector z=(z₁, z₂, . . . , zₖ), the softmax function softmax(z) is given by:

$${softmax ( z )}_{i} = \frac{{e}^{{z}_{i}}}{{\sum }_{j = 1}^{k} {e}^{{z}_{j}}} for i = 1 , 2 , … , k ,$$

where e is the base of the natural logarithm, and the numerator computes the exponential of each element of the input vector, while the denominator is the sum of the exponentials over all elements. This ensures that the resulting vector is a probability distribution over the classes.

### FC4—Scale Regression

This is analogous to FC2 but for scaling.

### FC5—PMF Estimation for Scale

This is analogous to FC3 but for scaling.

Of course, additional FC layers can be added, e.g., to handle translation and/or differential scale.

Now consider a specific example. To train a model of the above architecture (FIG. 5) we used the COCO2017 dataset for N_{θ}=50 and Nₛ=15. The dataset is discussed in T. Y. Lin, M. Maire, S, Belongie, J. Hays, P. Perona, D. Ramanan, P. Doll'ar, and C. L. Zitnick, Microsoft coco: Common objects in context, Proc. Computer Vision-ECCV, pp. 740-755, (2014), which is hereby incorporated herein by reference in its entirety. We use Stochastic Gradient Descent (SGD) with momentum and a learning rate that decays linearly across iterations for the optimization of the network. The overall loss function that we optimize is a weighted sum of five loss components, one for each FC layer. We use the binary cross entropy loss for the digital watermark presence/absence classifier loss. We use the Mean-Squared-Error (MSE) loss for both the rotation and scaling regression. Finally, we use the Kullback-Leibler divergence loss for optimizing both of the ambiguity resolution heads.

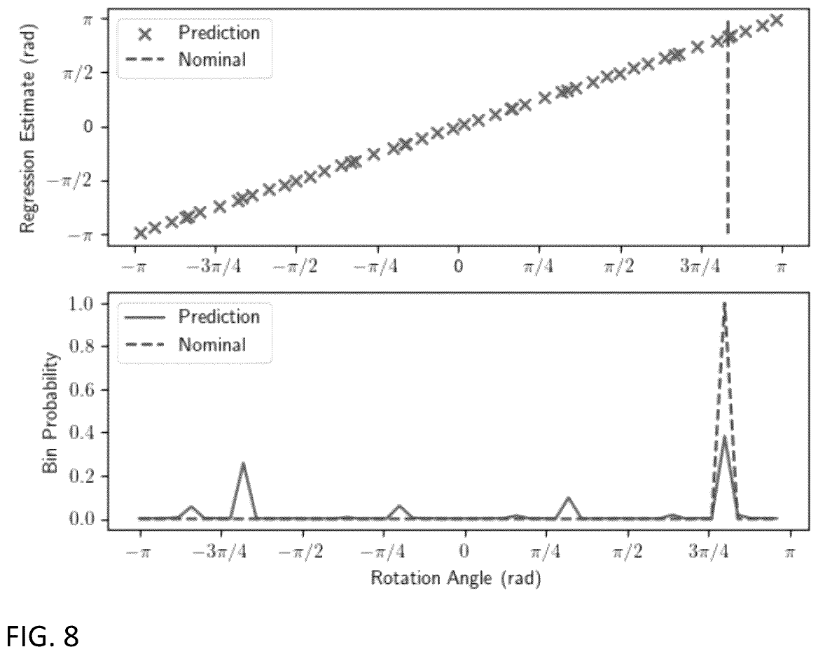

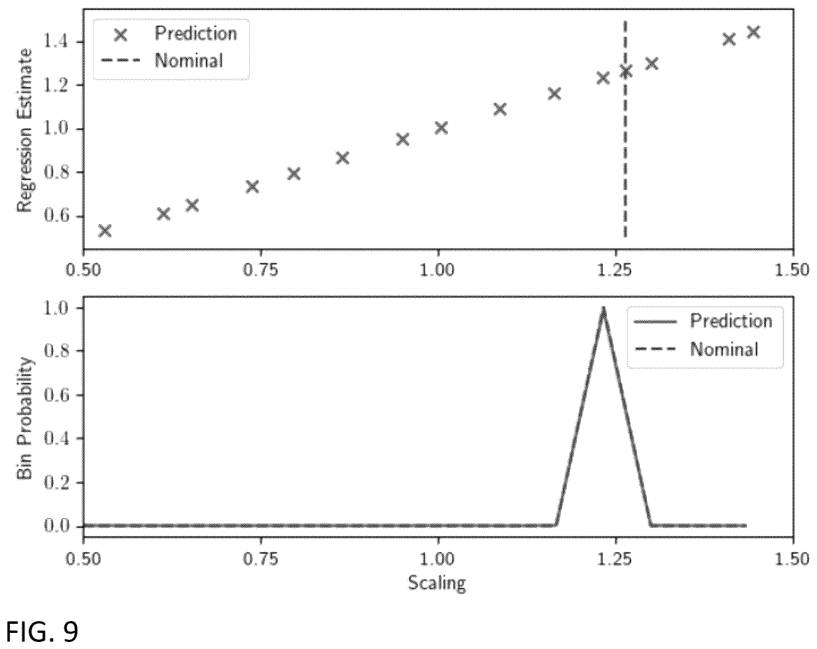

To illustrate the network's outputs using an example, we consider a test image sample that has been watermarked and has been distorted by rotation angle 0=2.6165 rad (or, 149.91 degrees) and scaling coefficient s=1.2637. In FIG. 8 (top), we illustrate the angle regression output (FC2) which comprises N_{θ} angle estimates. In FIG. 8 (bottom), we illustrate the bin probabilities computed by the network (FC3) which enable us to resolve the ambiguity of multiple angle estimates. Based on these probabilities, the best estimate is θ″=2.6189 rad (or, 150.05 degrees). Similarly, in FIG. 9 (top), we illustrate the scaling regression output (FC4) which comprises Nₛ scaling coefficient estimates. In FIG. 9 (bottom), we illustrate bin probabilities computed by the network (FC5) which enable us to resolve the ambiguity of multiple scaling coefficient estimates. Based on these probabilities, the best estimate is s″=1.2643.

We notice that the absolute errors for angle and scaling regression are 0.0024 rad (or, 0.14 degrees) and 0.0006, respectively. Early numerical studies suggest that the proposed method attains similar performance across a diverse test set which, in turn, implies that the network generalizes well to the task of interest.

In another example, we choose signal tile of size h′=256 and w′=256. We consider a full 360° image rotation range and scaling transformation in the range [0.25, 1.0], e.g., images are downsampled by up to 4× after being rotated. Both at training and testing stages, images are rotated and scaled followed by a crop of size 128×128 from random location. This combination of distortion and crop renders the problem harder/more realistic, since the affine transform estimator in this example, has access to image size 128×128 pixel. We train a CNN-based model using the COCO2017 dataset as the above. For training, we choose values of the strength factor α randomly between 0.05 and 0.30. Lower bound of 0.05 was chosen to make the problem harder and not all image blocks are expected to be watermarked at acceptable signal levels. Initial observation revealed capabilities of trained CNNs to estimate rotation of images without any watermark by relying on features of natural images as proposed in S. Gidaris, P. Singh, and N. Komodakis, Unsupervised Representation Learning by Predicting Image Rotations, International Conference on Learning Representations, arXiv preprint arXiv:1803.07728 (2018), which is hereby incorporated by reference. To make the estimation more challenging, we randomly rotate and scale unmarked images before digital watermarking as the estimator should rely on a digital watermark template signal and not on orientation from image content itself.

To illustrate the network results, we consider a set of 20,000 test image blocks of size 128×128 obtained from images preferably not seen in training and watermarked according to the embedding technology described in, e.g., U.S. Pat. No. 10,599,937, which is hereby incorporated herein by reference in its entirety, with randomly chosen strength factors α. FIG. 10 shows histograms of predicted rotation angles and scales after fixed rotation and scale configurations denoted with red cross. Rotation angle estimates are generally centered around target value modulo 180°. In practice, this may be resolved by targeted re-training or by further refining few most likely candidates.

FIG. 11 shows results of a DeepSync implementation trained on a digital watermarked images including an image template. The digital watermark signal included a zero-mean spread spectrum digital watermark image template such as in FIG. 4 (“watermark tile”) in A. Reed, T. Filler, K. Falkenstern, and Y. Bai, Watermarking spot colors in packaging, Proc. Media Watermarking, Security, and Forensics, pp. 46-58, (2015), incorporated by reference above. Inference Dataset included a COCO2017 test subset of approximately 40,000 image samples. The COCO2017 dataset is discussed further in T. Y. Lin, M. Maire, S, Belongie, J. Hays, P. Perona, D. Ramanan, P. Doll'ar, and C. L. Zitnick, Microsoft coco: Common objects in context, Proc. Computer Vision-ECCV, pp. 740-755, (2014), which is incorporated by reference above. The system included N (a positive integer) regressors for angle rotation (varies as shown in FIG. 11) and 10 regressors for scaling. The FIG. 11 graphs show plots of rotation estimates for different DeepSync implementation having different number N angle rotation regressors (and corresponding classifier bins). N ranges from 40 to 160. The arrow points to where 79% of samples (for N=160) include an absolute value error of less than 2%. Interestingly, all four test sets (e.g., N=40, 80, 120 and 160) achieve 79% of samples with an absolute value error of less than 3%. All version of these DeepSync implementations (e.g., classification+regression) have far superior results compared to a regression only implementation (e.g., a FIG. 3A implementation, shown with the dotted line in FIG. 11). For the curious reader, see Table 2, below, for hyperparameters used in the FIG. 11 implementations.

TABLE 2

| | | Learning | Weight | Rotation | Scale | Batch | |
|---|---|---|---|---|---|---|---|
| Backbone | Optimizer | Rate | Decay | Range | Range | Size | Epochs |
| EfficientNetB0 | Adam | 1e−5 | 1e−5 | (−180°, 180°) | (.5, 2) | 32 | 300 |

The Adam Optimizer is described further in Kingma, D. and Ba, J. (2015) Adam: A Method for Stochastic Optimization, Proceedings of the 3rd International Conference on Learning Representations (ICLR 2015), which is hereby incorporated herein by reference in its entirety. EffecientNetB0 is described further in Tan, M. and Le, Q. V. (2019) EfficientNet: Rethinking Model Scaling for Convolutional Neural Networks. Proceedings of the 36th International Conference on Machine Learning, ICML 2019, Long Beach, 9-15 Jun. 2019, 6105-6114), which is hereby incorporated herein by reference in its entirety. A “learning rate” is a hyperparameter that determines a size of the steps taken during the optimization process. Specifically, it controls how much to change the model's weights in response to the estimated error each time the model weights are updated. Learning rates can be fixed or adaptive. Adaptive learning rates change over time during training (e.g., decreasing as the training progresses). A weight decay hyperparameter includes a regularization technique used to prevent overfitting, which is a common problem in deep learning models like CNNs. Overfitting occurs when a model learns the training data too well, including the noise and outliers, and performs poorly on new, unseen data. Weight decay works by, e.g., adding a penalty term to the loss function. The most common form of this penalty is the L2 norm of the weights, multiplied by a regularization parameter (often denoted as lambda). This term penalizes large weights and effectively limits the complexity of the model. By including this term in the loss function, weight decay reduces the magnitude of the weights and helps to keep the model simpler, thereby reducing the risk of overfitting. An epoch, of course, refers to a pass through of the entire training dataset during the training process of a machine learning model.

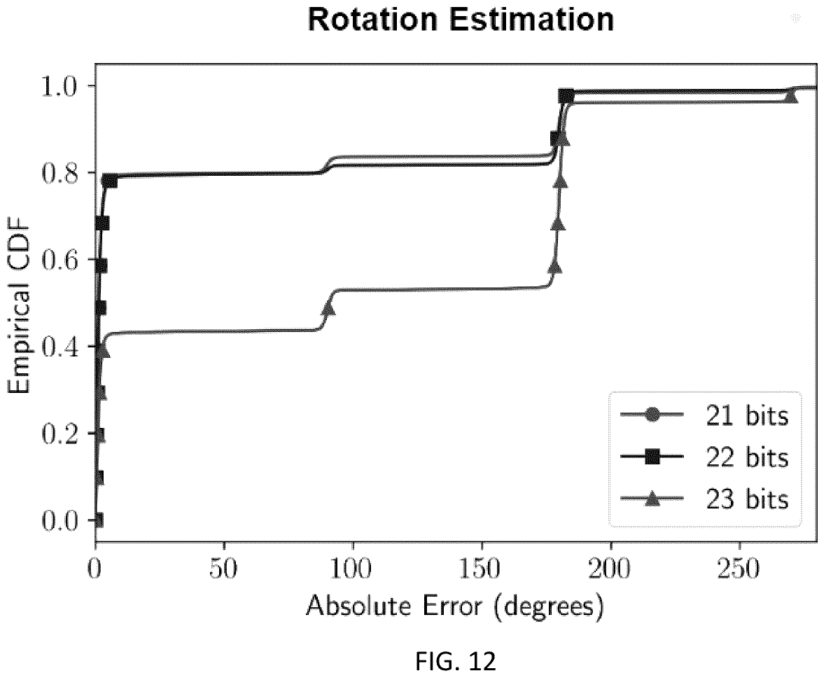

FIG. 12 shows results of a DeepSync implementation used prior to digital watermark detection using a HiDDen [1] implementation. [1]F. Zhu et al., “Hidden: Hiding Data with Deep Networks,” Proc. ECCV, pp. 657-672, (2018), incorporated by reference above. The HiDDen implementation was trained with message lengths of: (21, 22, 23), and a rotation tolerance: 12° 1. In this implementation, HiDDeN weights were frozen with no direct influence. Images were encoded with HiDDeN, rotated, and then DeepSync was trained on such. For the image dataset, approximately 40,000 samples from the COCO2017 [2] dataset were used. Interestingly, we observed 90° symmetry. This can be reworked by either attempting to read four times at different 90-degree rotations; or retrained to eliminate symmetries. Excellent results are expected from such.

See Appendix A—DeepSync: Affine Transform Recovery via Convolutional Neural Networks for Watermark Synchronization—for related embodiments. Appendix A is hereby incorporated herein by reference in its entirety and is expressly intended to form part of the written description of this specification. The documents [1]-[19] cited on page of Page 6/6 of Appendix A are also hereby incorporated herein by reference in their entirety.

### Additional Description and Operating Environments

Having described and illustrated certain arrangements, it should be understood that applicant's technology is not so limited.

For example, while embodiments of the technology were described based on one illustrative neural network architecture (of the so-called AlexNet variety), it will be recognized that different network topologies—now existing (as detailed in the incorporated-by-reference documents) and forthcoming—can be used, depending on the needs of particular applications. Neural networks have various forms and go by various names. Those that are particularly popular now are convolutional neural networks (CNNs)—sometimes termed deep convolutional networks (DCNNs), or deep learning systems, to emphasize their use of a large number of hidden (intermediate) layers. Exemplary writings in the field include:
Babenko, et al, Neural codes for image retrieval, arXiv preprint arXiv:1404.1777 (2014).
Donahue, et al, DeCAF: A Deep Convolutional Activation Feature for Generic Visual Recognition, Proc. 31^{st} Int'l Conference on Machine Learning, 2014, pp. 647-655.
Girshick, et al, Rich feature hierarchies for accurate object detection and semantic segmentation, Proc. IEEE Conference on Computer Vision and Pattern Recognition, 2014, p. 580-587.
He, Kaiming, et al, Deep residual learning for image recognition, arXiv preprint arXiv:1512.03385 (2015).
Held, et al, Deep learning for single-view instance recognition, arXiv preprint arXiv:1507.08286 (2015).
Jia, et al, Caffe: Convolutional architecture for fast feature embedding, Proceedings of the 22nd ACM International Conference on Multimedia, 2014, pp. 675-678.
Krizhevsky, et al, Imagenet classification with deep convolutional neural networks, Advances in Neural Information Processing Systems 2012, pp. 1097-1105.
Deep Learning for Object Recognition: DSP and Specialized Processor Optimizations, Whitepaper of the Embedded Vision Alliance, 2016.
   Each of the above documents are hereby incorporated herein by reference in its entirety.

Wikipedia articles for Machine Learning, Support Vector Machine, Convolutional Neural Network, and Gradient Descent are part of the specification of patent application 62/371,601, filed Aug. 5, 2016, which forms part of the disclosure of U.S. Pat. No. 10,515,429, both of which is hereby incorporated herein by reference in its entirety.

While some artisans may draw a distinction between the terms “layer” and “stage” in a neural network (e.g., a stage comprises a convolution layer, a max-pooling layer, and a ReLU layer), applicant does not maintain a strict distinction. Such terms may thus be regarded as synonyms herein.

In addition, or as an alternative, to indicating presence of a particular subject (e.g., a digital watermark pattern) in input imagery, a neural network according to the present technology can also be configured to determine and localize the position of such subject within the imagery. (Localization is commonly performed with many object recognition systems. See, e.g., the Girshick paper referenced above, and the paper by Sermanet, et al, Overfeat: Integrated recognition, localization and detection using convolutional networks, arXiv preprint arXiv:1312.6229, 2013. See also the paper by Oquab, et al, Is object localization for free?Weakly-supervised learning with convolutional neural networks, Proceedings of the IEEE Conference on Computer Vision and Pattern Recognition, 2015.

In a network that characterizes a watermark pattern by plural parameters, such as its scale range and its rotation range, etc., the network can employ plural sets of output layers—each trained to indicate a different one of the parameters.

Alternatively, a network with a single output stage can be trained to activate two output neurons in response to certain input imagery. One neuron can indicate the scale range in which a watermark pattern sensed in the imagery falls, and the other can indicate the rotation range in which such watermark pattern falls. The training of a classifier to respond to certain stimulus by activating two (or more) of plural output neurons is known in the art, as detailed by writings such as Bishop, Pattern Recognition and Machine Learning, Springer, 2007 (ISBN 0387310738). A relevant excerpt, from section 4.3.4 of the Bishop book, entitled Multiclass Logistic Regression. Further details are also disclosed in U.S. Pat. No. 10,664,722.

While the technology is illustrated in connection with analysis of 2D data, it should be understood that the same principles are likewise applicable to data of other dimensions.

Some researchers are urging more widespread use of deeper networks, such as the He paper cited above. With deeper networks, it can be cumbersome to manually select filter dimensions for each layer. Many researchers have thus proposed using higher level building blocks, such as “Inception modules” to simplify network design. Inception modules commonly include filters of several different dimensionalities (typically 1×1, 3×3, and sometimes 1×3, 3×1 and 5×5). Much work in the area has been done by Google, whose neural network patent publications teach these and many other features. See, e.g., patent documents U.S. Pat. Nos. 9,514,389, 9,911,069, 10,460,211, 10,467,493, and 10,521,718 the disclosures of which are incorporated herein by reference.

The large model sizes of some networks can be a challenge for implementation in certain environments, e.g., on mobile devices. Arrangements such as that taught by Iandola, SqueezeNet: AlexNet-level accuracy with 50× fewer parameters and <0.5 MB model size, arXiv preprint arXiv:1602.07360, 2016 can be employed to realize classifiers of lower complexity.

Another approach to reducing the network size is to employ a different type of classifier output structure. Most of the network size (required memory) is due to use of a fully-connected-layers (multi-layer perceptron) output arrangement. Different classification networks can be employed instead, such as an SVM or tree classifier, which may create decision boundaries otherwise—such as by a hyperplane. In one particular embodiment, the network is originally configured, and trained, using a multi-layer perceptron classifier. After training, this output structure is removed, and a different classifier structure is employed in its stead. Further training of the network can proceed with the new output structure in place. If new object classes are introduced, the network—employing the new output classifier—can be retrained as necessary to recognize the new classes.

While most neural networks used for image recognition operate on down-sampled imagery (e.g., a camera may capture a 2000×1000 pixel image, and it is down-sized by interpolation or otherwise by a factor of four or more to yield a 256×256 image for processing by the network), the technology can be employed to operate to full-resolution imagery, or imagery that has been down-sampled by a relatively small amount, e.g., by a factor of three or less.

While applicant's particular interests involve detecting, and sometimes characterizing, watermark patterns in imagery, the technologies detailed herein are not so limited. They can be used in any type of image recognition network. Examples include facial recognition, optical character recognition, vehicle navigation, medical diagnosis, analyzing video for offensive material, barcode reading, etc. Moreover, the same techniques are analogously applicable to recognition of audio and other so-called 1D data (whether the dimension is time or otherwise).

In a particular embodiment, a network according to the present technology is employed as a first, screening stage in a watermark detection system—used simply to flag the likely presence of a watermark in imagery, and perhaps to discern some information about its likely pose (scale, rotation and/or translation). If the network indicates likely presence of a watermark, then subsequent processing of the imagery is triggered. If not, then no further time needs to be devoted to that imagery.

If information about the watermark's likely pose state is produced, then this information can be used to narrow the range of poses over which the subsequent processing searches to find the watermark. For example, if a direct least squares technique is subsequently employed, as detailed in U.S. Pat. Nos. 9,959,587 and 10,242,434, which are each hereby incorporated herein by reference, then the “seeds” that define the pose search range can be chosen to focus on the general range(s) identified by the neural network.

In addition to the implementations discussed above, the present technology also can be implemented using Caffe—an open source framework for deep learning algorithms, distributed by the Berkeley Vision and Learning Center (Caffe provides a version of the “AlexNet” architecture that is pre-trained to distinguish 1000 “ImageNet” object classes.) Other suitable platforms to realize the arrangements detailed above include TensorFlow from Google, Theano from the Montreal Institute for Learning Algorithms, the Microsoft Cognitive Toolkit, Torch from the Dalle Molle Institute for Perpetual AI, MX-Net from a consortium including Amazon, Baidu and Carnegie Mellon University, and Tiny-DNN on Github.

For training, the Caffe toolset can be used in conjunction with a computer equipped with multiple Nvidia TitanX GPU cards. Each card includes 3,584 CUDA cores, and 12 GB of fast GDDR5X memory.

Once trained, the processing performed by the detailed neural networks is relatively modest. Some hardware has been developed especially for this purpose, e.g., to permit neural networks to be realized within the low power constraints of mobile devices. Examples include the Snapdragon 820 system-on-a-chip from Qualcomm, and the Tensilica T5 and T6 digital signal processors from Cadence. (Qualcomm provides an SDK designed to facilitate implementation of neural networks with its 820 chip: the Qualcomm Neural Processing Engine SDK.)

Alternatively, the trained neural networks can be implemented in a variety of other hardware structures, such as a microprocessor, an ASIC (Application Specific Integrated Circuit) and an FPGA (Field Programmable Gate Array). Hybrids of such arrangements can also be employed, such as reconfigurable hardware, and ASIPs.

By microprocessor, Applicant means a particular structure, namely a multipurpose, clock-driven, integrated circuit that includes both integer and floating-point arithmetic logic units (ALUs), control logic, a collection of registers, and scratchpad memory (aka cache memory), linked by fixed bus interconnects. The control logic fetches instruction codes from a memory (often external) and initiates a sequence of operations required for the ALUs to carry out the instruction code. The instruction codes are drawn from a limited vocabulary of instructions, which may be regarded as the microprocessor's native instruction set.

A particular implementation of one of the above-detailed arrangements on a microprocessor can begin by first defining the sequence of operations in a high level computer language, such as MatLab or C++(sometimes termed source code), and then using a commercially available compiler (such as the Intel C++ compiler) to generate machine code (i.e., instructions in the native instruction set, sometimes termed object code) from the source code. (Both the source code and the machine code are regarded as software instructions herein.) The process is then executed by instructing the microprocessor to execute the compiled code.

Many microprocessors are now amalgamations of several simpler microprocessors (termed “cores”). Such arrangements allow multiple operations to be executed in parallel. (Some elements—such as the bus structure and cache memory may be shared between the cores.) Examples of microprocessor structures include the Intel Xeon, Atom and Core-I series of devices. They are attractive choices in many applications because they are off-the-shelf components. Implementation need not wait for custom design/fabrication.

Closely related to microprocessors are GPUs (Graphics Processing Units). GPUs are similar to microprocessors in that they include ALUs, control logic, registers, cache, and fixed bus interconnects. However, the native instruction sets of GPUs are commonly optimized for image/video processing tasks, such as moving large blocks of data to and from memory and performing identical operations simultaneously on multiple sets of data (e.g., pixels or pixel blocks). Other specialized tasks, such as rotating and translating arrays of vertex data into different coordinate systems, and interpolation, are also generally supported. The leading vendors of GPU hardware include Nvidia, ATI/AMD, and Intel. As used herein, Applicant intends references to microprocessors to also encompass GPUs.

GPUs are attractive structural choices for execution of the detailed arrangements, due to the nature of the data being processed, and the opportunities for parallelism.

While microprocessors can be reprogrammed, by suitable software, to perform a variety of different algorithms, ASICs cannot. While a particular Intel microprocessor might be programmed today to perform neural network item identification, and programmed tomorrow to prepare a user's tax return, an ASIC structure does not have this flexibility. Rather, an ASIC is designed and fabricated to serve a dedicated task, or limited set of tasks. It is purpose-built.

An ASIC structure comprises an array of circuitry that is custom designed to perform a particular function. There are two general classes: gate array (sometimes termed semi-custom), and full-custom. In the former, the hardware comprises a regular array of (typically) millions of digital logic gates (e.g., XOR and/or AND gates), fabricated in diffusion layers and spread across a silicon substrate. Metallization layers, defining a custom interconnect, are then applied—permanently linking certain of the gates in a fixed topology. (A consequence of this hardware structure is that many of the fabricated gates—commonly a majority—are typically left unused.)

In full-custom ASICs, however, the arrangement of gates is custom-designed to serve the intended purpose (e.g., to perform a specified function). The custom design makes more efficient use of the available substrate space—allowing shorter signal paths and higher speed performance. Full-custom ASICs can also be fabricated to include analog components, and other circuits.

Generally speaking, ASIC-based implementations of the detailed arrangements offer higher performance, and consume less power, than implementations employing microprocessors. A drawback, however, is the significant time and expense required to design and fabricate circuitry that is tailor-made for one particular application.

An ASIC-based implementation of one of the above arrangements again can begin by defining the sequence of algorithm operations in a source code, such as MatLab or C++. However, instead of compiling to the native instruction set of a multipurpose microprocessor, the source code is compiled to a “hardware description language,” such as VHDL (an IEEE standard), using a compiler such as HDLCoder (available from MathWorks). The VHDL output is then applied to a hardware synthesis program, such as Design Compiler by Synopsis, HDL Designer by Mentor Graphics, or Encounter RTL Compiler by Cadence Design Systems. The hardware synthesis program provides output data specifying a particular array of electronic logic gates that will realize the technology in hardware form, as a special-purpose machine dedicated to such purpose. This output data is then provided to a semiconductor fabrication contractor, which uses it to produce the customized silicon part. (Suitable contractors include TSMC, Global Foundries, and ON Semiconductors.) A third hardware structure that can be used to implement the above-detailed arrangements is an FPGA. An FPGA is a cousin to the semi-custom gate array discussed above. However, instead of using metallization layers to define a fixed interconnect between a generic array of gates, the interconnect is defined by a network of switches that can be electrically configured (and reconfigured) to be either on or off. The configuration data is stored in, and read from, a memory (which may be external). By such arrangement, the linking of the logic gates—and thus the functionality of the circuit—can be changed at will, by loading different configuration instructions from the memory, which reconfigure how these interconnect switches are set.

FPGAs also differ from semi-custom gate arrays in that they commonly do not consist wholly of simple gates. Instead, FPGAs can include some logic elements configured to perform complex combinational functions. Also, memory elements (e.g., flip-flops, but more typically complete blocks of RAM memory) can be included. Again, the reconfigurable interconnect that characterizes FPGAs enables such additional elements to be incorporated at desired locations within a larger circuit.

Examples of FPGA structures include the Stratix FPGA from Altera (now Intel), and the Spartan FPGA from Xilinx.

As with the other hardware structures, implementation of the above-detailed arrangements begins by specifying the operations in a high-level language. And, as with the ASIC implementation, the high-level language is next compiled into VHDL. But then the interconnect configuration instructions are generated from the VHDL by a software tool specific to the family of FPGA being used (e.g., Stratix/Spartan).

Hybrids of the foregoing structures can also be used to implement the detailed arrangements. One structure employs a microprocessor that is integrated on a substrate as a component of an ASIC. Such arrangement is termed a System on a Chip (SOC). Similarly, a microprocessor can be among the elements available for reconfigurable interconnection with other elements in an FPGA. Such arrangement may be termed a System on a Programmable Chip (SORC).

Another hybrid approach, termed reconfigurable hardware by the Applicant, employs one or more ASIC elements. However, certain aspects of the ASIC operation can be reconfigured by parameters stored in one or more memories. For example, the weights of convolution kernels can be defined by parameters stored in a re-writable memory. By such arrangement, the same ASIC may be incorporated into two disparate devices, which employ different convolution kernels. One may be a device that employs a neural network to recognize grocery items. Another may be a device that employs a neural network to read license plates. The chips are all identically produced in a single semiconductor fab but are differentiated in their end-use by different kernel data stored in memory (which may be on-chip or off).

Yet another hybrid approach employs application-specific instruction set processors (ASIPS). ASIPS can be thought of as microprocessors. However, instead of having multi-purpose native instruction sets, the instruction set is tailored—in the design stage, prior to fabrication—to a particular intended use. Thus, an ASIP may be designed to include native instructions that serve operations associated with some or all of: convolution, max-pooling, ReLU, etc., etc. However, such native instruction set would lack certain of the instructions available in more general-purpose microprocessors.

Reconfigurable hardware and ASIP arrangements are further detailed in U.S. Pat. No. 9,819,950, the disclosure of which is incorporated herein by reference.

In addition to the toolsets developed especially for neural networks, familiar image processing libraries such as OpenCV can be employed to perform many of the methods detailed in this specification. Software instructions for implementing the detailed functionality can also be authored by the artisan in C, C++, MatLab, Visual Basic, Java, Python, Tcl, Perl, Scheme, Ruby, etc., based on the descriptions provided herein.

Software and hardware configuration data/instructions are commonly stored as instructions in one or more data structures conveyed by tangible media, such as magnetic or optical discs, memory cards, ROM, etc., which may be accessed across a network.

This specification has discussed several different arrangements. It should be understood that the methods, elements and features detailed in connection with one arrangement can be combined with the methods, elements and features detailed in connection with other arrangements. While some such arrangements have been particularly described, many have not—due to the large number of permutations and combinations.

While this disclosure has detailed particular ordering of acts and particular combinations of elements, it will be recognized that other contemplated methods may re-order acts (possibly omitting some and adding others), and other contemplated combinations may omit some elements and add others, etc.

Although disclosed as complete systems, sub-combinations of the detailed arrangements are also separately contemplated (e.g., omitting various of the features of a complete system).

While certain aspects of the technology have been described by reference to illustrative methods, it will be recognized that apparatuses configured to perform the acts of such methods are also contemplated as part of Applicant's inventive work. Likewise, other aspects have been described by reference to illustrative apparatus, and the methodology performed by such apparatus is likewise within the scope of the present technology. Still further, tangible computer readable media containing instructions for configuring a processor or other programmable system to perform such methods is also expressly contemplated.

To provide a comprehensive disclosure, while complying with the Patent Act's requirement of conciseness, Applicant incorporates-by-reference each of the documents referenced herein including those in the attached Appendix A. (Such materials are incorporated in their entireties, even if cited above in connection with specific of their teachings.) These references disclose technologies and teachings that Applicant intends be incorporated into the arrangements detailed herein including those in Appendix A, and into which the technologies and teachings presently detailed be incorporated.

1-32. (canceled)

33. A system comprising:
a processor; and
memory storing instructions that, when executed by the processor, cause the system to: receive input imagery;
process the input imagery using a convolutional neural network (CNN) to extract image features;
analyze extracted image features using a plurality of fully connected (FC) layers to:
detect presence or absence of a digital watermark signal embedded in the input imagery;
classify an image rotation angle of the input imagery into one of a plurality of angle rotation bins; and
refine a rotation angle estimate within a classified angle rotation bin;
determine presence of the digital watermark signal based on output of a first FC layer;
determine a refined rotation angle estimate for the input imagery based on outputs of a second FC layer and a third FC layer; and
process the input imagery based on the refined rotation angle estimate.

34. The system of claim 33, wherein the plurality of FC layers further analyzes the extracted image features to:
classify an image scaling factor of the input imagery into one of a plurality of scaling bins; and
refine a scaling factor estimate within a classified scaling bin.

35. The system of claim 34, wherein the instructions further cause the system to:
determine a refined scaling factor estimate for the input imagery based on outputs of fourth and fifth FC layers.

36. The system of claim 33, wherein classifying the image rotation angle comprises:
generating, by the second FC layer, probabilities for each of the plurality of angle rotation bins; and
selecting an angle rotation bin with a highest probability.

37. The system of claim 36, wherein refining the rotation angle estimate comprises:
applying, by the third FC layer, a regression model to estimate a specific rotation angle within a selected angle rotation bin.

38. The system of claim 33, wherein the instructions further cause the system to:
geometrically transform the input imagery based on the refined rotation angle estimate to produce transformed imagery; and
decode the digital watermark signal from the transformed imagery.

39. The system of claim 33 in which the transformed imagery comprises video or a still image.

40. The system of claim 33, wherein the CNN comprises a feature extraction backbone including multiple convolutional layers and pooling layers.

41. The system of claim 33, wherein the first FC layer employs a binary classification algorithm to detect the presence or absence of the digital watermark signal.

42. The system of claim 33, wherein the second FC layer utilizes a softmax function to estimate probabilities for the plurality of angle rotation bins.

43. The system of claim 33, wherein the third FC layer employs a regression model to refine the rotation angle estimate within the classified angle rotation bin.

44-54. (canceled)

55. A method comprising:
receiving input imagery;
processing the input imagery using a convolutional neural network (CNN) to extract image features;
analyzing extracted image features using a plurality of fully connected (FC) layers to:
detect presence or absence of a digital watermark signal embedded in the input imagery;
classify an image rotation angle of the input imagery into one of a plurality of angle rotation bins;
refine a rotation angle estimate within a classified angle rotation bin;
classify an image scaling factor of the input imagery into one of a plurality of scaling bins; and
refine a scaling factor estimate within a classified scaling bin;
determining presence of the digital watermark signal based on output of a first FC layer;
determining a refined rotation angle estimate for the input imagery based on outputs of second and third FC layers;
determining a refined scaling factor estimate for the input imagery based on outputs of fourth and fifth FC layers; and
processing the input imagery based on the refined rotation angle estimate and the refined scaling factor estimate.

56. The method of claim 55, further comprising:
geometrically transforming the input imagery based on the refined rotation angle estimate and the refined scaling factor estimate to produce transformed imagery; and
decoding the digital watermark signal from the transformed imagery.

57. A system for image analysis, comprising:
means for receiving input imagery;
means for extracting image features from the input imagery;
means for detecting presence or absence of a digital watermark signal embedded in the input imagery based on extracted image features;
means for classifying an image rotation angle of the input imagery into one of a plurality of angle rotation bins;
means for refining a rotation angle estimate within a classified angle rotation bin;
means for classifying an image scaling factor of the input imagery into one of a plurality of scaling bins;
means for refining a scaling factor estimate within a classified scaling bin; and
means for processing the input imagery based on a refined rotation angle estimate and a refined scaling factor estimate.

58. The system of claim 57, wherein the means for extracting image features comprises a convolutional neural network (CNN) including multiple convolutional layers and pooling layers.

59. The system of claim 57, wherein the means for detecting presence or absence of a digital watermark signal comprises a fully connected layer employing a binary classification algorithm.

60. The system of claim 57, wherein the means for classifying an image rotation angle comprises a fully connected layer utilizing a softmax function to estimate probabilities for each of the plurality of angle rotation bins.

61. The system of claim 57, wherein the means for refining a rotation angle estimate comprises a fully connected layer employing a regression model to estimate a specific rotation angle within the classified angle rotation bin.

62. The system of claim 57, wherein the means for classifying an image scaling factor comprises a fully connected layer utilizing a softmax function to estimate probabilities for each of the plurality of scaling bins.

63. The system of claim 57, wherein the means for refining a scaling factor estimate comprises a fully connected layer employing a regression model to estimate a specific scaling factor within the classified scaling bin.

64. The system of claim 57, further comprising:
means for geometrically transforming the input imagery based on the refined rotation angle estimate and the refined scaling factor estimate to produce transformed imagery; and
means for decoding the digital watermark signal from the transformed imagery.

65. The system of claim 64 in which the transformed imagery comprise video or a still image.

66. The system of claim 57, wherein the means for classifying an image rotation angle and the means for classifying an image scaling factor utilize a Kullback-Leibler divergence loss function during training.

67. The system of claim 57, wherein the means for refining a rotation angle estimate and the means for refining a scaling factor estimate utilize a mean squared error loss function during training.

68. The system of claim 57 in which the input imagery comprises video or a still image.
